(19) United States
(12) Patent Application Publication
(10) Pub. No.: US 2007/0159321 A1
(43) Pub. Date: Jul. 12, 2007

(54) Sensor node, base station, sensor network and sensing data transmission method

(76) Inventors: Yuji Ogata, Hachioji (JP); Shunzo Yamashita, Musashino (JP); Takeshi Tanaka, Akishima (JP)

Correspondence Address: REED SMITH LLP;Suite 1400, 3110 Fairview Park Drive, Falls Church, VA, 22042, US

(21) Appl. No.: 11/642,928

(22) Filed: Dec. 21, 2006

(30) Foreign Application Priority Data
Jan. 6, 2006 (JP) 2006-001252

(51) Int. Cl. G08B 1/08

(52) U.S. Cl. 340/539.12

(57) ABSTRACT

To provide suppressing loss of sensing data while suppressing current consumption at a sensor node, a sensor node is started at a predetermined interval, a sensor measures data (P143), the measurement data is sent to a base station (P144), a state of wireless communication with the base station is determined (P145), and if the wireless communication state is not suitable for data transmission, the data is stored in a sensor node storage device (P147), whereas if the wireless communication state is suitable for data transmission, the data stored in the storage device is transmitted (P148).

### CLAIM OF PRIORITY

The present application claims priority from Japanese application JP 2006-001252 filed on Jan. 6, 2006, the content of which is hereby incorporated by reference into this application.

### FIELD OF THE INVENTION

The present invention relates to a sensor node with a wireless communications function which can be used with a sensor network, and modification of a base station in a sensor network.

### BACKGROUND OF THE INVENTION

In recent years, small electronic circuits having a wireless communications function are being added to sensors, and network systems (henceforth sensor networks) which input various information about the real world into an information processing unit in real time, are being examined.

Sensor networks may have wide-ranging applications, for example medical applications wherein, in small scale electronic circuits incorporating a radio circuit, processor, sensor and a battery, physiological functions such as pulse can be continuously monitored, the monitoring results transmitted to a diagnostic equipment or device by wireless communications, and a health state determined based on the monitoring results (for example, JP-A 041952/2000, JP-A 070266/2001, JP-A 118421/2003, JP-A 275272/2004, JP-A 075311/1997, JP-A 113653/1997, and JP-A 000551/2003).

In order to implement sensor networks in practical use, it is important that an electronic circuit (henceforth a sensor node) having a wireless communications function, a sensor and a power supply such as a battery, remains maintenance-free over a long time, that data continues to be transmitted, and that the circuit has a compact external appearance.

For this reason, development of compact sensor nodes which can be installed anywhere is now under way.

At the present stage, from the viewpoints of maintenance cost and user-friendliness, it is important that the equipment can be used for about 1 year without replacing batteries.

### SUMMARY OF THE INVENTION

The aforesaid prior art sensor node has a construction wherein a sensor is driven and sensor data is collected periodically (for example, JP-A 075311/1997).

The sensing data collected by the sensor node is transmitted to a base station, etc. by wireless communications, and the sensing data of each sensor node is stored in the base station. With a sensor node which collects physiological data such as pulse, the sensor must always be carried on the body, but it may not be possible to transmit sensing data when a person is separated from the base station, or in a location where the state of wireless communications is unstable.

Also, with a stationary sensor node or if there are instruments and devices which affect the wireless communication state, when the wireless communication state is unstable, it may not be possible to transmit sensing data to the base station.

In this state, if the sensor node continues searching for the base station or waiting for a reply signal, the limited battery capacity will be consumed unnecessarily, it will soon become necessary to replace (or charge) the batteries in the sensor node, maintenance will be required more frequently, and user-friendliness will fall.

When a sensor node measures physiological data such as pulse, it is desired that the base station which accumulates sensing data should avoid loss of time series sensing data as far as possible. In particular, in a sensor network which monitors physiological data, although the physiological data at any particular time is important, there is also a need to increase monitoring precision by being aware of changes in physiological data over time.

However, in the aforesaid prior art sensor node, since the sensor is driven and measurement is started at a predetermined timing, and the measured sensing data is sent to the base station as it is, if the wireless communication state is unstable, sensing data might be lost.

Therefore, the present invention, which was conceived in view of the aforesaid problem, provides a sensor node and sensor network which can suppress loss of sensing data while suppressing battery power consumption.

The invention is a sensor network comprising a sensor node having a sensor which measures data at a predetermined interval, a first wireless communication part which transmits the data measured by said sensor to a base station, and a controller which controls the sensor and wireless communication part, and also comprising a base station having a second wireless communication part which transmits/receives data to and from said sensor node, a database which stores data received from the sensor node and a control unit which controls the second wireless communication part and database; wherein the controller of the sensor node has a clock part which starts the sensor at the predetermined interval; a wireless communication state determining part which, when the sensor measures the latest data, determines a wireless communication state by transmitting the latest measurement data; a storage part which, if the determined wireless communication state is a state which is not suitable for transmitting data, stores the latest measurement data; and a data transmission part which, if the determined wireless communication state is a state which is suitable for transmitting data, transmits the data stored in the storage part; and wherein the controller of the base station has a reply part which transmits a reply signal in response to the sensor node when data is received from the sensor node; and the wireless communication state determining part determines a state of wireless communication with the base station based on whether or not the reply signal was received.

A sensor node is started with a predetermined period, measures the latest information by a sensor, and transmits it to a base station. In the case of a wireless communication state in which a reply signal from the base station to the latest measurement data transmitted from the sensor node is not received, it is determined that the state is not suitable for data transmission, data transmission is suspended, and unnecessary consumption of the battery in the sensor node is prevented by accumulating data in a storage part. In other words, by transmitting the latest measurement data, the quality of the wireless communication state can be determined and it can be determined whether or not to transmit the subsequent contents of the storage part, so it is unnecessary to verify the wireless communication state alone and battery consumption can be suppressed.

If, on the next occasion measurement data is transmitted, the wireless communication state is a suitable state for data transmission, after transmitting the latest measurement data to the base station, the previous measurement data accumulated in the storage part is transmitted. Hence, even in an environment where the wireless communication state is unstable, the latest measurement information and accumulated measurement information can be transmitted to the base station when the wireless communication state is stable, and loss of measurement information in the base station can be suppressed. Moreover, loss of measurement data can be suppressed without incurring costs, such as installing plural base stations or installing a relay for relaying the wireless communications of the sensor node and the base station.

### BRIEF DESCRIPTION OF THE DRAWINGS

FIG. 1 is a partial cutaway view showing the front of a wrist-band type sensor node and antenna describing a first embodiment of the invention, where the sensor node is fitted to the left wrist;

FIG. 2 is a diagram describing the arrangement of a pulse sensor when the bottom surface of a case is viewed from the top surface;

FIG. 3 is a block diagram showing an example of a health management sensor network system implemented by the wrist-band type sensor node of the invention;

FIG. 4 shows an example of the format of data which is sent/received between a sensor node and a base station BS10. (a) shows time setting command data, (b) shows time setting end data, (c) shows transmission data, and (d) shows association request data;

FIG. 5 is a flow chart showing an example of a control program executed by the sensor node, and a control program executed by the base station;

FIG. 6 is a block diagram showing the construction of a nonvolatile memory EEPROM;

FIG. 7 is a block diagram showing the construction of a main memory RAM;

FIG. 8 is a flow chart showing a subroutine of delayed transmission data storage processing performed in P147 of FIG. 5;

FIG. 9 is a flow chart showing a subroutine of a battery remaining amount check processing performed in P1501 of FIG. 8;

FIG. 10 is a graph showing a voltage of a battery BAT and an elapsed time, showing the relation between an EEPROM data transfer voltage setting value and a node operation limit;

FIG. 11 is a flow chart showing a subroutine of an EEPROM write processing performed in P1507 of FIG. 8;

FIG. 12 is a graph showing the relation between a delayed transmission data storage size and time, and showing the conditions for changing over a storage location between a ring buffer RNG1 of the main memory RAM and the EEPROM;

FIG. 13 is a flow chart showing a subroutine for an untransmitted data determination performed in P145 of FIG. 5.

FIG. 14 is a flow chart showing a subroutine for an untransmitted data read processing performed in P148 of FIG. 5;

FIG. 15 is a flow chart showing a subroutine for a RAM read processing performed in P1803 of FIG. 14;

FIG. 16 is a flow chart showing a subroutine for an initialization performed in P135 of FIG. 5;

FIG. 17 is a descriptive diagram showing a time data format of a sensor node;

FIG. 18 is a graph showing the relation between a power consumption of a sensor node and time when transmit/receive is performed normally;

FIG. 19 is a graph showing the relation between a power consumption of a sensor node and time during transmit/receive, when a reply signal ACK could not be received from the base station BS10;

FIG. 20 is a graph showing the relation between a power consumption of a sensor node and time when transmit/receive is performed normally, and sensing data was accumulated on the immediately preceding startup;

FIG. 21 is a graph showing the relation between a reception sensitivity and time in a base station according to the positional relation between the sensor node and the base station;

FIG. 22 is a plan view of a residence provided with a sensor network;

FIG. 23 is a plan view of another residence provided with a sensor network;

FIG. 24 is a descriptive diagram showing a sensor node fitting position, and a person's orientation;

FIG. 25 is a graph showing a transmission intensity of a sensor node according to a person's orientation; and

FIG. 26 is a block diagram of an example of a sensor network system showing a second embodiment of the invention.

### DESCRIPTION OF THE PREFERRED EMBODIMENTS

Hereafter, an exemplary embodiment of the invention will be described referring to the drawings.

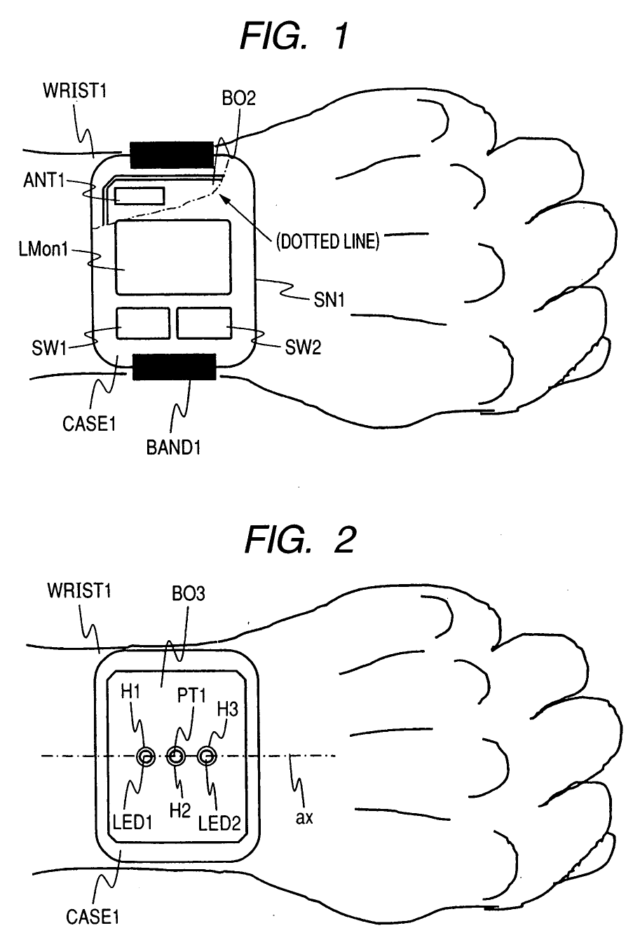

FIG. 1 is an elevational view showing a first aspect wherein the invention is applied to a bracelet type (or wrist watch type) sensor node SN1. This sensor node SN1 mainly measures a person's pulse.

### <Outline of Sensor Node>

A display unit LMon1 which displays messages is arranged in the center of a rectangular case CASE1 having four sides. The display unit LMon1 may be a liquid crystal display or the like. On the second side opposite to a first side which is a CASE1 edge at the 6:00 position of the wrist watch from the first side which is the CASE1 edge at the 12:00 position of the wrist watch, a band BAND1 for fixing a sensor node SN1 to the arm is attached. FIG. 1 shows a state where the left arm (WRIST1) is equipped with the sensor node SN1.

A substrate BO2 described later is disposed so that an emergency switch SW1 and measurement switch SW2 are oriented in the length direction of the arm between the band BAND1 of the lower limit of the case CASE1 and the display LMon1, are exposed on the surface of the case CASE1, and can be operated by the wearer. The switch SW1 for example notifies an emergency to the outside when the wearer operates it in an emergency, and the switch SW2 is operated to measure physiological data (pulse, etc.), or in response to a query from the display LMon1, etc. These switches are classically push button type switches, but other types of switch may also be used.

An antenna ANT1 is disposed on the substrate BO2 inside the case CASE1 between the band BAND1 on the upper edge of the case CASE1, and the display LMon1. This antenna ANT1 may be for example a tipped type dielectric antenna which uses a “high dielectric”.

The sensor SN1 is a pulse sensor which measures pulse, a temperature sensor which measures body temperature or ambient temperature, a sensor which detects the motion of the wearer (body), or typically, an acceleration sensor. However, it is not limited to an acceleration sensor, and may be another type of sensor which can detect motion.

FIG. 2 is a diagram showing the layout of the pulse sensor disposed on the bottom surface of the case CASE1. The pulse sensor used by the bracelet type sensor node SN1 of the invention comprises an infrared light emitting diode and a phototransistor as a photoreceptor unit. In addition to a photo-transistor, the photoreceptor element may be a photodiode. A pair of infrared light emitting diodes (light emitting elements) LED1, LED2 and a photo-transistor (photoreceptor unit) PT1 are provided in three openings H1-H3 made in the bottom of case CASE1, and disposed so that each element is facing the skin thus forming the pulse sensor.

In this pulse sensor, the blood vessels under the skin are irradiated with infrared light generated by the infrared light-emitting diodes LED 1 and 2, the variation of the scattered light intensity from the blood vessels due to blood-flow fluctuation is detected by the photo-transistor PT1, and the pulse is estimated from the period of the intensity variation.

The infrared light-emitting diodes LED 1, 2 and phototransistor PT1 are installed on a substrate B03, described later, so that the light-emitting diodes LED 1, 2 and phototransistor PT1 are disposed along an axis ax which perpendicularly intersects the center part of the line joining the up/down directions (12:00 and 6:00 of the wrist watch) of the case CASE1, the phototransistor PT1 being disposed between the infrared light-emitting diodes LED 1, LED 2 so that the phototransistor PT1 is sandwiched by them.

Specifically, in order to acquire a stable pulse reading, blood circulation fluctuations must be tracked efficiently. Due to the unique layout of the invention shown in FIG. 2, i.e., by arranging the infrared light emitting diodes LED1, LED2 and phototransistor PT1 in a straight line, when the arm is equipped with this bracelet type sensor node SN1, the LED 1 and 2 and phototransistor can be disposed along the blood vessels running through the arm, i.e., along the intravascular blood flow.

Further, as shown in FIG. 2, by disposing these infrared LED 1 and 2 and photo-transistor PT1 in the center of the bracelet type sensor node SN, the infrared light emitting diode LED 1 and 2 and photo-transistor PT1 can be fitted closely to the arm, i.e., to the blood vessels for sensing even when the user (wearer) moves. As a result, the intensity fluctuation of infrared scattered light due to blood flow fluctuation can be stably and efficiently tracked by the phototransistor PT1.

### <Construction of Sensor Node>

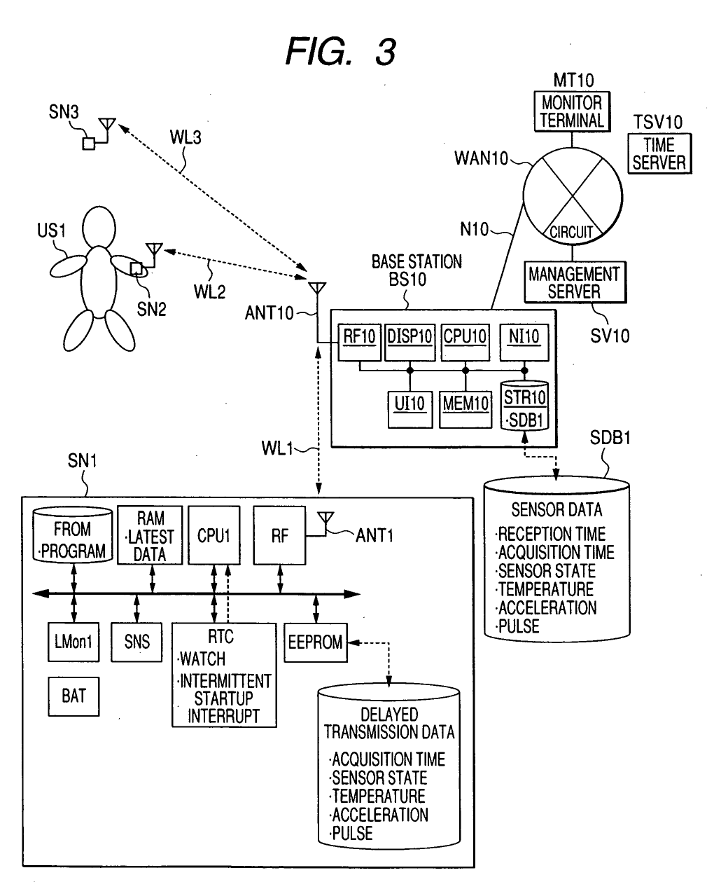

FIG. 3 is a block diagram showing the interior of the sensor node SN1, and the overall sensor network.

In FIG. 3, the sensor node SN1 comprises a processor CPU1 which performs computations, a radio-frequency part RF which performs wireless communications with a base station BS10 via an antenna ANT1, a main memory RAM (a volatile memory=DRAM or SRAM) which can be rewritten without performing a storage hold operation after power supply interruption, a rewritable flash memory FROM which can perform a storage hold operation and stores a program which controls the sensor node SN1, a rewritable nonvolatile memory EEPROM which can perform a storage hold operation, a real-time clock RTC which counts time, a sensor SNS which measures physiological data, a monitor LMon1 which displays information, and a battery BAT for driving the sensor node SN1. A battery BAT1 is for example a secondary battery (lithium ion secondary battery) which is rechargeable.

The sensor SNS comprises plural sensors, i.e., a pulse sensor, a temperature sensor, and an acceleration sensor, but in the following description, these sensors are collectively referred to as SNS.

The processor CPU1 is not always operating. It is started at a predetermined period (for example, 5 min, etc.) by an interrupt of the real-time clock RTC. After physiological data from the sensor SNS is measured, and the measured physiological data and measurement times are transmitted to the base station BS10, the processor shifts to standby mode (software standby), and waits for the next interrupt. In the standby mode (software standby), the power supply to the sensor SNS which measures physiological data is interrupted, and since the processor CPU1 is on standby where it can accept only an interrupt from the real-time clock RTC, the power consumption (e.g., 1 μA or less) can be suppressed. In other words, the component members of the sensor node SN1 suppress consumption of the battery BAT by operating intermittently. The processing performed by the sensor node SN1 will be described later. The sensor nodes SN2, SN3 are constituted in an identical way to that of the sensor node SN1.

### <Outline of Sensor Network>

The sensor network of FIG. 3 is a system drawing showing an example of a health management sensor net system using the bracelet type sensor node SN1 of the invention.

In FIG. 3, SN1-SN3 are the bracelet type sensor nodes of the invention. For example, they are fitted to a user's arm to monitor the health condition of a user US1. These bracelet type sensor nodes SN1-SN3 perform wireless communications with the base station BS10 by radio WL1-WL3. The sensor nodes SN 1-3 transmit sensed temperature and pulse data to the base station BS10.

The base station BS10 consists of an antenna ANT10, a radio-frequency part RF10, processor CPU10, memory MEM10, secondary storage STR10, display unit DISP10, user interface unit UI10 and network interface NI10. Among these, typically, the secondary storage STR10 consists of a hard disk or the like. The database SDB1 which stores the data collected by the base station BS10 from the dependent sensor nodes SN1-SN3 is stored in the secondary storage STR10. The display unit DISP10 is a CRT or the like. Typically, the user interface unit UI10 is a keyboard/mouse.

Apart from wireless communications with the sensor nodes SN 1-3, the base station BS10 can communicate with, for example, a management server SV10, monitor terminal MT10 and time server TSV10 via the network interface NI10 via a wide area network WAN10. The management server SV10 is provided with a CPU, memory, secondary storage, and network interface which are not illustrated, and it manages the sensing data collected from base station BS10 using a database or the like. The time server TSV10 and monitor terminal MT10 are similarly provided with a CPU, a memory, secondary storage and network interface. The time server TSV10 provides standard time to the computers connected to the wide area network WAN10. The wide area network WAN10 typically connects to the Internet.

Here, the base station BS10 manages the database SDB1 stored in the secondary storage STR10, and it provides the management server SV10 with the accumulated sensing data of the sensor nodes SN1-SN3. The base station BS10 also acquires standard time from the time server TSV10, provides the dependent sensor nodes SN1-SN3 with the standard time, and synchronizes time. In the database SDB1 of the base station BS10, the sensing data received from the sensor nodes SN1-SN3 is stored, for example one sensing data consisting of a receiving time, sensing data capture time, sensor state (state relating to physiological data), acquired temperature, acceleration and pulse.

Due to the above construction, the sensor nodes SN1-SN3 start the processor CPU1 with a predetermined time period, and measure physiological data. An outline of the management of the sensor nodes SN 1-3 will now be described. The sensor nodes SN1-SN3 write to a main memory RAM by using the measured physiological data and measurement times (capture times) as sensing data. Communication with the base station BS10 is performed, and the latest sensing data in the main memory RAM is transmitted.

If the sensing data transmitted by the sensor nodes SN1-SN3 is received normally, the base station BS10 transmits a reply signal ACK to the sensor nodes SN1-SN3, and when the sensor nodes SN1-SN3 receive the reply signal ACK in response to the transmitted sensing data, they terminate the communication, shift to the status of software standby again, and enter a waiting state until the following time period.

On the other hand, when the sensor nodes SN1-SN3 are far from the base station BS10, or when the sensor nodes SN1-SN3 cannot connect with the base station BS10 due to a wireless communication disturbance, transmission of sensing data is repeated a predetermined number of times. This predetermined number of times can be set freely. If the reply signal ACK from the base station BS10 is not subsequently received, the sensor nodes SN1-SN3 hold the latest sensing data in the main memory RAM, stop data transmission, and stand by until the following time period. Before the processor CPU1 shifts to the waiting state, the latest sensing data in the main memory RAM is written to and accumulated in a ring buffer set in the main memory RAM, or the latest sensing data is written to and accumulated in a ring buffer set in the nonvolatile memory EEPROM.

After the predetermined time period elapses and the processor CPU1 starts due to an interrupt from the real-time clock RTC, physiological data is measured, and transmitted to the base station BS10 as sensing data together with the measurement time. If the reply signal ACK is received from the base station BS10 at this time, all the sensing data held in the ring buffer of the aforesaid main memory RAM or nonvolatile memory EEPROM which has not yet been transmitted, is transmitted together (continuously).

Due to the above management, when there is no connection between the sensor nodes SN1-SN3 and the base station BS10, unnecessary power consumption of the battery BAT by repeatedly transmitting data when the wireless communication state is unstable, is suppressed by holding data in the storage part of the sensor nodes SN1-SN3. In the next and subsequent communications, when data transmission to the base station BS10 is successful, by collectively transmitting previous sensing data which was held in the storage part of the sensor nodes SN1-SN3, loss of sensing data stored in the database SDB1 of the base station BS10 is prevented.

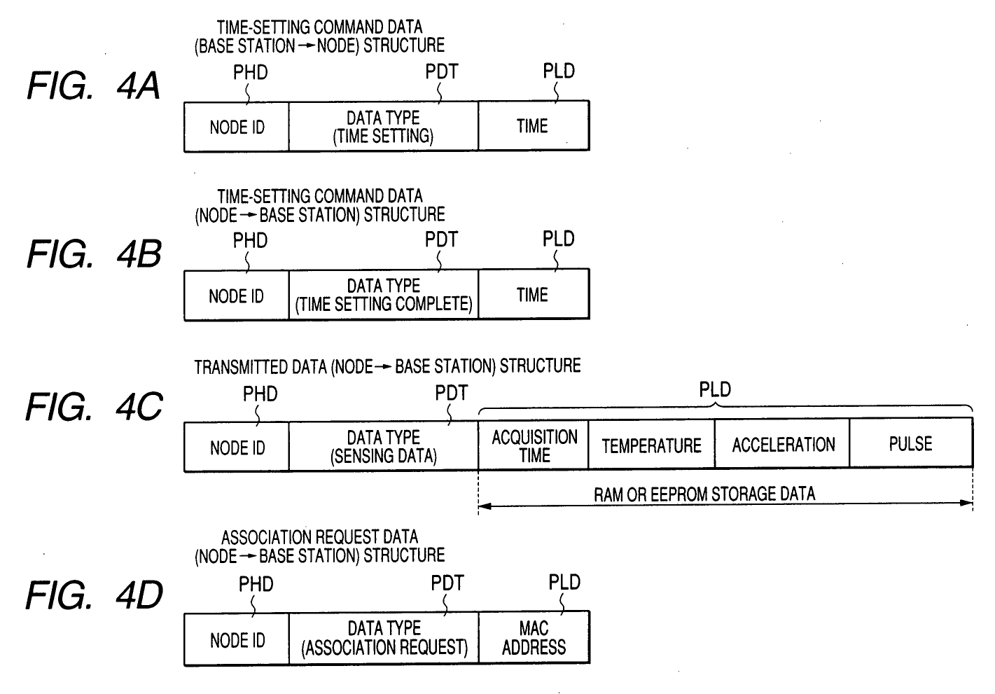

FIG. 4 shows an example of packets transmitted and received by the health management sensor net system of FIG. 3 between the sensor nodes SN 1-3 and the base station BS10. Hereafter, the sensor nodes SN1-SN3 are identical, so only the sensor node SN1 will be described.

FIG. 4(a) is a packet of time setting command data transmitted to the sensor nodes SN1-SN3 from the base station BS10 in order to synchronize the real-time clock RTC of the sensor nodes SN1-SN3 with the standard time of the time server TSV10.

The packets transmitted and received between the sensor nodes SN1-SN3 and the base station BS10 consist of a header part PHD which stores the node ID of the destination, a data type PDT which stores the type of data to be transmitted, and a payload part PLD which stores data.

In the case of this time setting command data, the node ID of the sensor nodes SN1-SN3 is stored in the header part PHD, the value which shows the time setting is stored in the data type PDT, and time data is stored in the payload part PLD.

FIG. 4(b) shows a packet transmitted by the sensor nodes SN1-SN3 to the base station BS10, when the time setting has been completed. In the case of this time setting completion data, the node ID of the base station BS10 is stored in the header part PHD, a value which shows time setting completion is stored in the data type PDT, and time data is stored in the payload part PLD.

FIG. 4(c) shows a transmission data packet when the sensor nodes SN1-SN3 transmit measured sensing data to the base station BS10. In the case of this sensing data, the node ID of the base station BS10 is stored in the header part PHD, a value which shows sensing data is stored in the data type PDT, and the time (capture time) when the sensing data was acquired, measured temperature, acceleration and pulse are stored in the payload part PLD.

As described above, if data transmission is not completed normally, in the transmission data packet of FIG. 4(c), the sensor nodes SN1-SN3 store the capture time, temperature, acceleration and pulse as a set of sensing data in the ring buffer of the main memory RAM or nonvolatile memory EEPROM, and hold them until the next successful transmission.

FIG. 4(d) shows an association request packet transmitted by the sensor nodes SN1-SN3 to the base station BS10. In this association request, the node ID of the base station BS10 is stored in the header part PHD, a value which shows an association request is stored in the data type PDT, and unique identifiers, such as the MAC address set in a radio-frequency part RF of the sensor node SN1, are stored in the payload part PLD.

### <Control of Sensor Node>

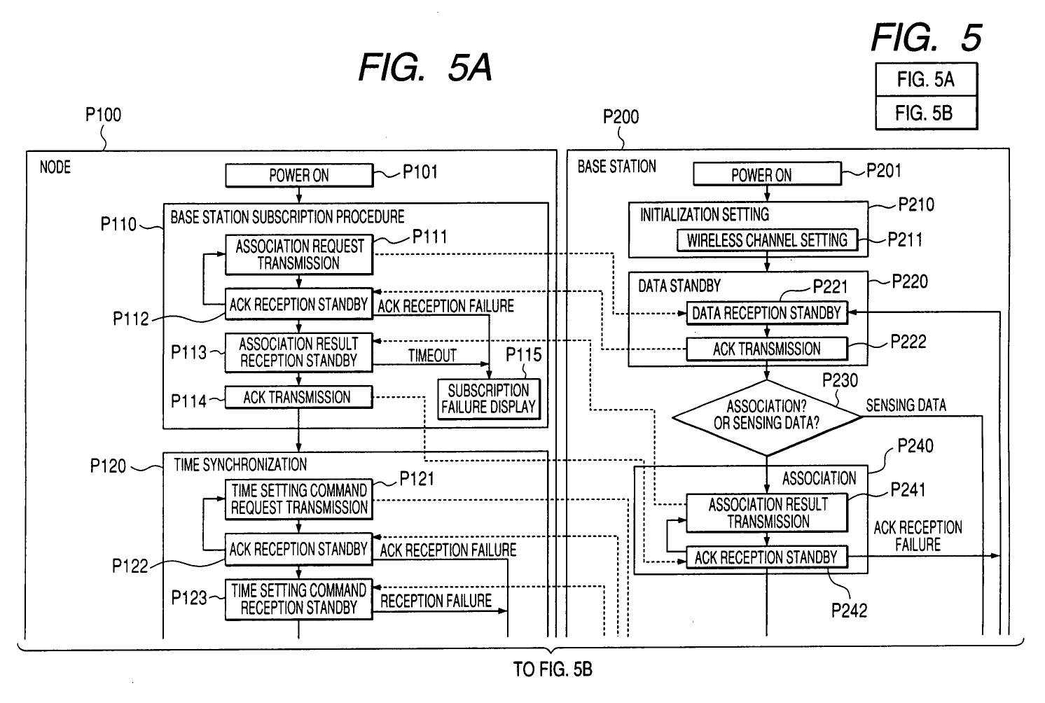

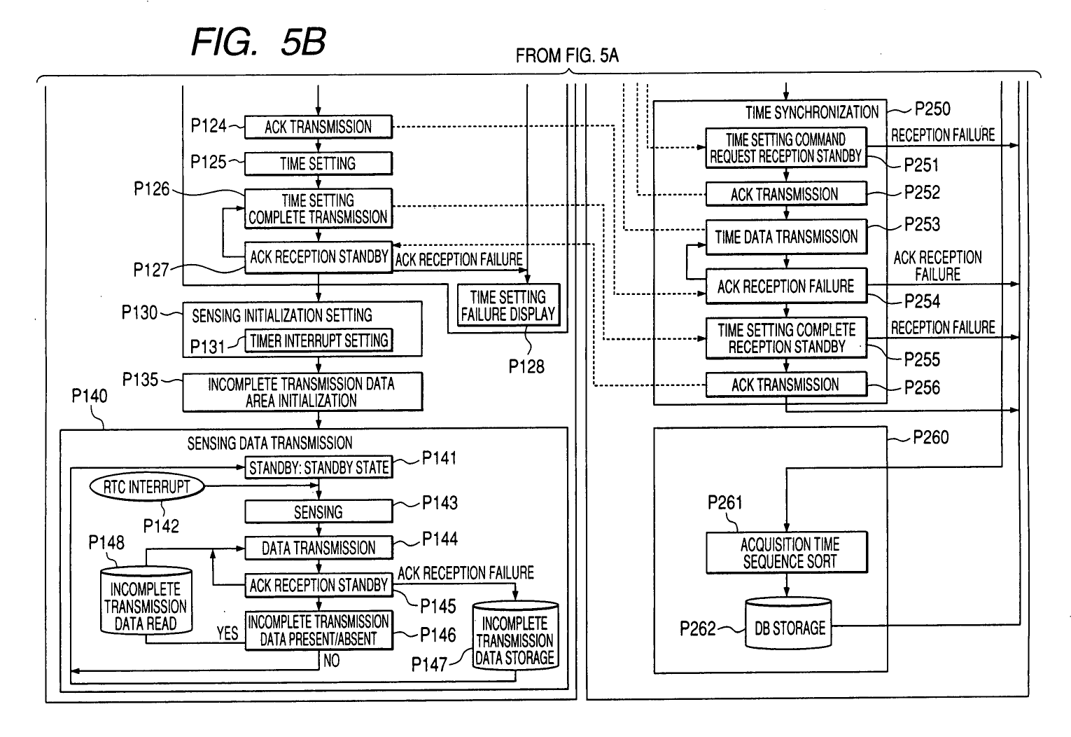

FIG. 5 is a flow chart which shows an example of the communication control performed by the sensor node SN1 and base station BS10. In the figure, a program P100 shows the processing performed by the sensor node SN1, and a program 200 shows the processing performed by the base station BS10. These two routines P100 and P200 perform the communication shown by the dotted lines in the figure.

First, the control routine P100 performed by the sensor node SN1 will be described.

When the sensor node SN1 is switched ON (P101), a subscription procedure P110 for subscribing to the connectable base station BS10 is implemented.

In the base station subscription procedure P110, an association request subscription request) is first transmitted to the base station BS10 (P111). At this time, the sensor node SN1 transmits unique identifiers, such as the MAC address set by a radio-frequency part RF, to the base station BS10.

Next, it waits for reception of the reply signal ACK in response to the association request (P112). When the reply signal ACK is received, it is determined that the association request has been normally received by the base station BS10, and reception of an association result is awaited (P113).

On the other hand, if the reply signal ACK has not been received even if a predetermined period (several msec) elapses, the routine returns to the process P111 and an association request is transmitted. If the processes P111 and P112 are repeated a predetermined number of times (for example, 3), and the reply signal ACK has not been received even if the predetermined number of times is exceeded, it is determined that the wireless communication state become unstable, and the routine proceeds to P115. The number of predetermined times can be set freely. In P115, it is displayed on the display LMon1 that the subscription to the base station BS10 failed, and processing is terminated. Hence, when the wireless communication state is unstable, or when a fault has occurred in the base station BS10, the sensor node SN1 is prevented from making endless association requests leading to unnecessary power consumption of the battery BAT.

In P113, when the sensor node SN1 receives an association result, the reply signal ACK is transmitted to the base station BS10 (P114). The routine then proceeds to a time synchronization process P120 which synchronizes the time of the base station BS10 and the sensor node SN1. As an association result, for example, the node ID which the base station BS10 assigned to the sensor node SN1 is notified. Henceforth, the sensor node SN1 is managed by the node ID assigned by the station BS10. The communication rate and channel of the wireless communication between the sensor node SN1 and base station BS10 are preset values. By considering the communication rate and channel as fixed, the control program of the sensor node SN1 can be simplified, the load on the processor CPU1 can be reduced, and power consumption can be suppressed.

On the other hand, if the association result has not been received even if the predetermined time (several hundred msec) elapsed in P113, the routine proceeds to the aforesaid P115, and it is displayed on the display Lmon1 that subscription to the base station BS10 failed. Due to this, when the wireless communication state become unstable or a fault occurs in the base station BS10, the system is prevented from waiting for an association result without any restriction, and unnecessarily consuming the battery BAT. When the routine has proceeded to P115, after the predetermined time (for example, 10 min) has elapsed, it returns to P111 and the base station subscription procedure P110 is repeated.

When the aforesaid base station subscription procedure P110 is complete, the sensor node SN1 performs the time synchronization process P120 which synchronizes the base station BS10 with time.

The sensor node SN1 transmits a time setting request command to the base station BS10 (P121). In P122, the system waits for the reply signal ACK in response to this time setting request command, and if the reply signal ACK is received, it is determined that the time setting request command was accepted normally. On the other hand, if the reply signal ACK was not received even after the predetermined time (several msec) has elapsed, the routine returns to the processing of P121, and the time setting request command is retransmitted. However, in the repeat processing of P121, if the reply signal ACK was not received after a predetermined number of times as an upper limit (e.g., 3), it is determined that the wireless communication state is unstable, and the routine proceeds to P128. This number of predetermined times can be set freely. In P123, the system waits for reception of time setting command data (FIG. 4(a)) from the base station BS10. When the time setting command data is received from the base station BS10, the routine proceeds to P124, and the reply signal ACK is returned to the base station BS10. On the other hand, if the time setting command data could not be received within specified time, the routine proceeds to P128.

After returning the reply signal ACK in P124, the value of the real-time clock RTC of the sensor node SN1 is set as the received time (P125). The sensor node SN1 then transmits the time setting completion data shown in FIG. 4(b) to the base station BS10 (P126). In P127, the routine waits for the reply signal ACK from the base station BS10 in response to the time setting completion data. When the reply signal ACK is received from the base station BS10, the time synchronization process P120 is complete and the routine proceeds to the next sensing initialization setting process P130. On the other hand, if the reply signal ACK was not received even after the predetermined time (for example, several msec) elapses, the routine proceeds to P128.

If the reply signal ACK was not received from the base station BS10 by the above P122, P123 and P127, the fact that time synchronization with the base station BS10 failed, is displayed on the display unit LMon1. This prevents repeating transmission of the time setting command without any restriction, or waiting for the reply signal ACK without any restriction leading to unnecessary consumption of the battery BAT, when the wireless communication state become unstable or a fault occurs in the base station BS10. After the routine proceeds to P128, when the predetermined time (for example, 10 min) has elapsed, the routine returns to P121, and the time synchronization process P120 is repeated.

The base station BS10 requests the time server TSV10 for the standard time with a predetermined period, and makes the real-time clock RTC of the base station BS10 agree with the standard time.

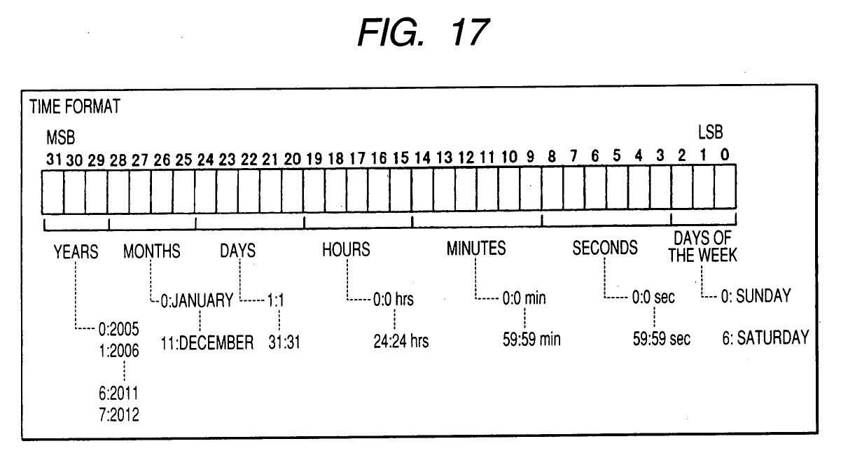

Here, the data format of the time used by the real-time clock RTC of the sensor node SN1 is shown in FIG. 17. In general, in a general-purpose OS such as UNIX®, the date and time is expressed as a serial value from a standard time, and when displaying the date and time, the serial value is converted into “day/month/year, hours/min/sec” which can be understood by a human operator.

On the other hand, in the sensor node SN1, consumption of the battery BAT must be reduced as much as possible by reducing the amount of operations of the processor CPU1 as much as possible. For this reason, as shown in FIG. 17, a data format which expresses “year/month/day/hours/min/second/day of the week” as 32 bits from the upper bit is used for the time data of the real-time clock RTC of sensor node SN1. In the case of the process P120 of time synchronization with the base station BS10, the base station BS10 changes its own time data into the 32-bit time data format used by the sensor node SN1, stores it in the time data of the payload part PLD shown in FIG. 4(a), and transmits it to the sensor node SN1.

In the sensor node SN1, since it is sufficient to display the value of the real-time clock RTC without modification when displaying time, conversion of the above time data does not occur, the amount of operations is reduced, and consumption of the battery BAT is suppressed.

Next, the sensing initialization setting process P130 will be described. In the sensor net system of the invention, the sensor node SN1 spontaneously transmits sensing data to the base station BS10 with a predetermined period. For this purpose, the sensor node SN1 initializes the predetermined period at which sensing data is transmitted to the base station BS10 by the sensing initialization setting process P130, and shifts to the measurement operating state.

In the sensing initialization setting process P130, a control parameter (initial value) stored beforehand in the nonvolatile memory EEPROM is read, and the interrupt period (for example, 5 min) of the real-time clock RTC is set (P131). Due to this processing, the processor CPU1 is started, physiological data is measured with a predetermined period, and transmission of physiological data and measurement times is repeated intermittently.

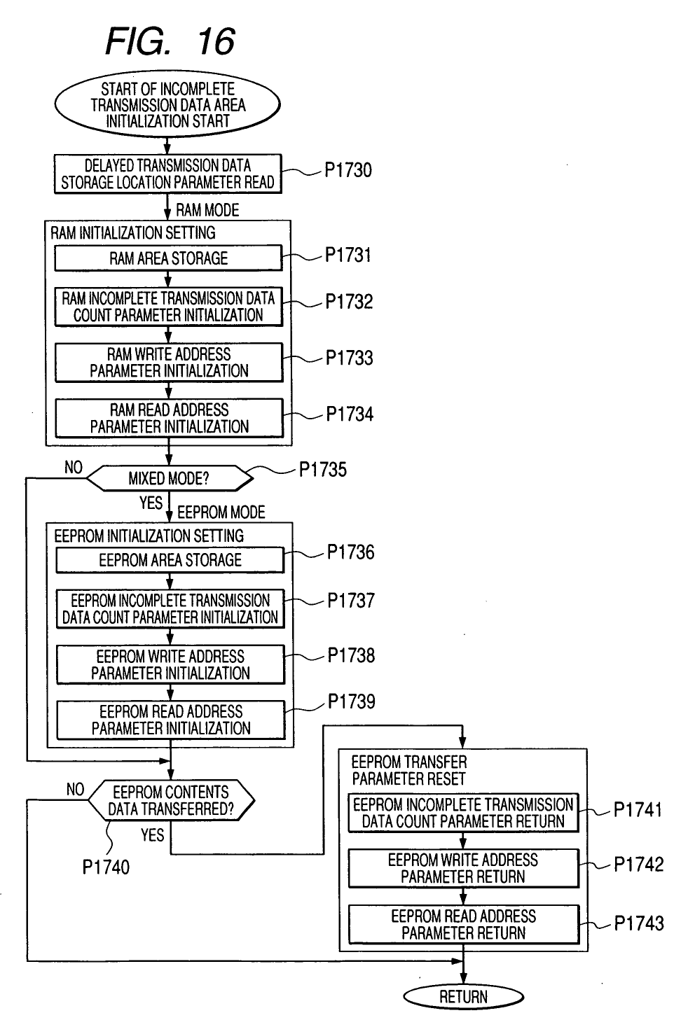

After the sensing initialization setting process P130 is completed, the routine proceeds to a process P135 for initializing a memory area. The initialization of the memory area will now be described, referring to the flow chart of FIG. 16.

The mode stored in a delayed transmission data storage location is read from a variable area VAL of the main memory RAM (P1730). Next, P1731-P1734 show RAM mode processing. First, in P1731, the RAM ring buffer size is read from a parameter range PRM of the nonvolatile memory EEPROM, and an area corresponding to the size read into the main memory RAM is set. In P1732-P1734, initialization of the number of untransmitted RAM data, RAM write addresses and RAM read addresses, are performed, respectively.

Next, in P1735, it is determined whether the present untransmitted data storage mode is a mixed mode. In the case of a mixed mode, the routine proceeds to P1736, and when it is not, the routine proceeds to P1740.

In the case of the mixed mode, first, the EEPROM ring buffer size is read from the parameter range PRM of the nonvolatile memory EEPROM, and an area corresponding to the size read into the nonvolatile memory EEPROM is set. In P1737-P1739, initialization of the number of untransmitted EEPROM data, EEPROM write addresses and EEPROM read addresses, are performed, respectively.

Next, an EEPROM transfer data flag is read from the parameter range PRM of the nonvolatile memory EEPROM in P1740, and it is determined whether or not this flag is set. If this flag is set, the transfer parameter return processing of P1741-P1743 is performed. First, in P1741, the number of untransmitted EEPROM data is read from the data transferred from the main memory RAM, and set to the number of untransmitted EEPROM data of the parameter area PRM. Similarly, in P1742 and P1743, an EEPROM write address and EEPROM read address are read from the data transferred from the main memory RAM, and set as the EEPROM write address and EEPROM read address of the parameter range PRM. Due to this processing, the data transferred from the main memory RAM can be used in the EEPROM mode.

Next, the routine shifts to a sensing data transmission process P140. In the sensing data transmission process P140, first, the processor CPU1 stands by in the standby state, and waits for an interrupt from the real-time clock RTC (P141). The real-time clock RTC applies the interrupt to the processor CPU1 with the predetermined period set by the above P131 (P142). After the processor CPU1 is started by the real-time clock RTC (startup state) and the processing of the following P143-P148 is performed, the routine returns to P141 again, and then returns to the standby state.

When the processor CPU1 enters the startup state, the sensor SNS is started, and physiological data is acquired in the order of the acceleration sensor, pulse sensor and temperature sensor (P143). More specifically, based on the measured value of the acceleration sensor, it is determined whether the wearer of the sensor node SN1 is in a resting state suitable for pulse measurement, and if he is in a resting state, the pulse sensor is driven and the pulse is measured. If he is not in a resting state, the physiological data measured by the acceleration sensor and the temperature sensor are measured.

When measurement of the physiological data of the sensor SNS is complete, the measured physiological data and measurement time are temporarily stored in a latest data storage area (described hereafter), of the main memory RAM. Next, as shown in FIG. 4(c), a transmission data packet is generated from sensing data consisting of pairs of physiological data, acquisition time, temperature, acceleration and pulse, and the sensing data is transmitted to the base station BS10 (P144).

Next, in P145, the reply signal ACK from the base station BS10 in response to this transmit data is awaited, and if the reply signal ACK has been received, it is determined that the transmit data has been accepted normally, and the routine proceeds to P146. On the other hand, if the reply signal ACK has not been received even after a predetermined time (several msec) elapsed, the routine returns to the processing of P144, and the transmission data packet is retransmitted. However, if the processing of P144 is repeated more than a predetermined number of times as an upper limit (for example, 3), and the reply signal ACK was not received, it is determined that the wireless communication state is unstable (wireless communication state is unstable for sensing data transmission), and the routine proceeds to P147.

When transmission of sensing data is completed normally, the routine proceeds to P146, and it is determined whether there is untransmitted sensing data remaining in the ring buffer RNG1 set in the main memory RAM, or in the ring buffer RNG2 set in the nonvolatile memory EEPROM, described later. In other words, in this case, it is determined that the wireless communication state is suitable for transmission of sensing data. If untransmitted sensing data (delayed transmission data) remains in the ring buffer RNG1 or RNG2, the routine proceeds to P148 and the untransmitted sensing data is read from the ring buffer; the routine returns to P144 and a transmission data packet is generated and transmitted to the base station BS10. The processing of P148, P144, and P145 is repeated until there is no more untransmitted sensing data in the determination of P146. When transmission of all untransmitted sensing data is complete in the determination of P146, the routine returns to P141, the processor CPU1 shifts to a standby state, and stands by until the following period.

In the processing of P145, when the reply signal ACK in response to transmitted data was not received from the base station BS10 in P147, if transmission of the initial data failed, the sensing data stored in the latest data location in the main memory RAM, is stored in the ring buffer which is the present write target, and the routine stands by until the next time the processor CPU1 starts. Also, if data transmission failed when untransmitted sensing data was transmitted, a pointer (read address) of the ring buffer used as the present read target is decremented by one.

Hence, if transmission fails when sensing data is transmitted, data transmission will be retried up to the predetermined number of times, but when the predetermined number of times is exceeded, the latest sensing data is stored in the ring buffer, and the routine stands by until the next data transmission. In other words, although the sensor node SN1 is started with a predetermined period and sensing data is sent to the base station BS10, when there is no reply signal ACK from the base station BS10, it is assumed that the wireless communication state is unstable, or there is a fault in the base station BS10. For this reason, when retry of data transmission is repeated without any limit, there is a possibility of using up the residual amount of the battery BAT which has a capacity limitation.

Hence, according to the present invention, retries are limited to several times when data transmission has failed, and unnecessary consumption of the battery BAT is suppressed. The sensing data which comprises measured physiological data and measurement times, is simultaneously stored in pairs in the ring buffer. When the wireless communication state improves, by sending previously untransmitted sensing data together after the latest sensing data, loss of sensing data stored in the base station BS10 is suppressed while suppressing wear of the battery BAT.

### <Memory Structure of Sensor Node>

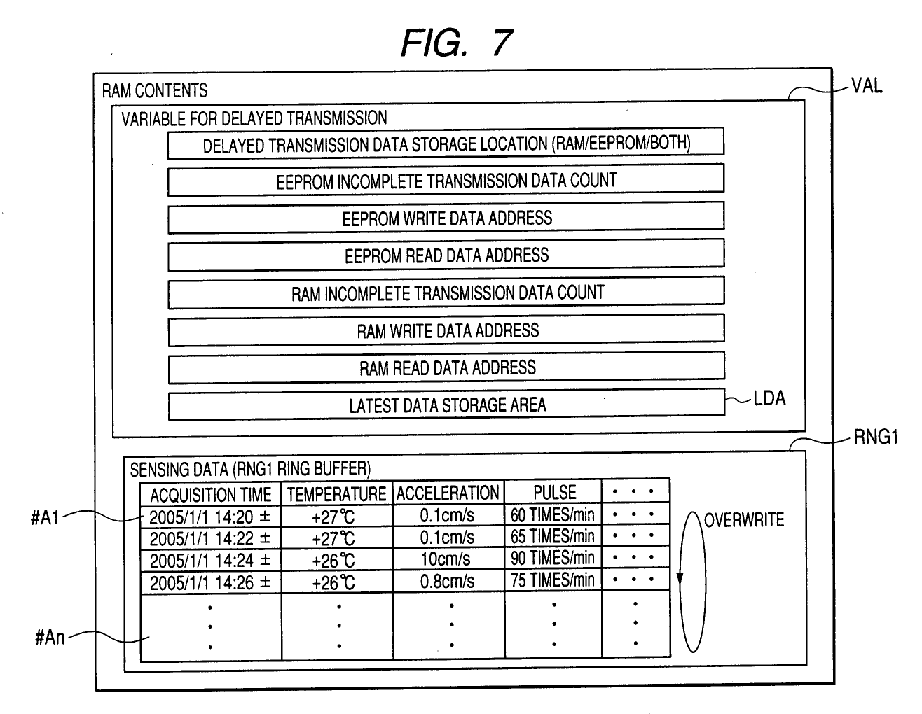

Next, the structure of the memory used by the sensor node SN1 will be described. As shown in FIG. 3, the sensor node SN1 has three types of memories, a flash memory FROM, nonvolatile memory EEPROM and main memory RAM. Programs such as the control routine P100 are stored in the flash memory FROM. As shown in FIG. 7, information (addresses, etc.) relating to the latest data storage area LDA for storing the latest sensing data and the storage location of untransmitted data, and the first ring buffer RNG, is set in the main memory RAM. The control parameter PRM of the sensor node SN1 and the second ring buffer RNG are set in the nonvolatile memory EEPROM.

In the present invention, when data transmission has failed, the latest sensing data is stored in the ring buffer sequentially, and when transmission with the base station BS10 is successful, previous sensing data which had not yet been transmitted is transmitted together after the latest sensing data.

Further, to reduce power consumption during a write operation to the memory, when the capacity (residual amount) of the battery BAT is sufficient, untransmitted sensing data is written to the ring buffer RNG1 of the main memory RAM which has a low voltage during write. On the other hand, when the capacity of the battery BAT falls below a predetermined value, the storage location is changed to the ring buffer RNG2 of the nonvolatile memory EEPROM so that untransmitted sensing data is not lost even if the storage hold operation of the main memory RAM stops.

Thereby, if the capacity of the battery BAT is sufficiently high, low power consumption of the sensor node SN1 can be attained because sensing data is stored in the main memory RAM which has a low power consumption during write, and which also has no limit on the number of writes. The durability of the sensor node SN1 is increased by suppressing use of the nonvolatile memory EEPROM which has a limit to the number of writes. Further, by setting the area in which sensing data is written to the nonvolatile memory EEPROM as the ring buffer RNG2, frequent updating of the same address is prevented, the number of sensing data writes can be made substantially equal, and the usage time of the nonvolatile memory EEPROM can be extended.

When the capacity of the battery BAT is sufficient, and when the wireless communication state is unstable and there is no more space in the ring buffer RNG1 of the main memory RAM, untransmitted sensing data may be stored in the ring buffer RNG2 of the nonvolatile memory EEPROM. In this case, the ring buffer RNG1 of the main memory RAM and the ring buffer RNG2 of the nonvolatile memory EEPROM are connected, and made to function as one ring buffer. Due to this, the memory area in which untransmitted sensing data is saved can be expanded.

### <Nonvolatile Memory EEPROM>

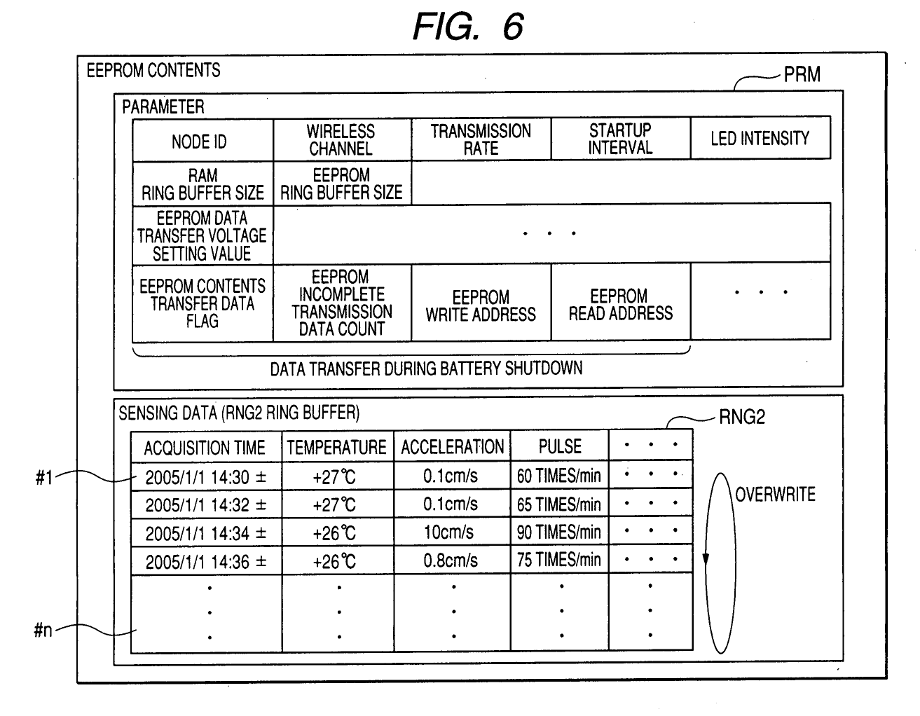

First, the contents of the nonvolatile memory EEPROM which stores control parameters and untransmitted sensing data (untransmitted data), will be described referring to FIG. 6.

In the nonvolatile memory EEPROM, the parameter storage PRM holding the control data of the sensor node SN1 and the ring buffer RNG2 which stores untransmitted sensing data transferred from the ring buffer RNG1 of the main memory RAM, are set.

The parameter storage part PRM contains the node ID assigned to the parameter storage PRM from the base station BS10, the channel which stores the frequency at which communication with the base station BS10 is performed, the transmission rate which stores the rate at which communication with the base station BS10 is performed, the startup interval which stores the interrupt occurrence period (startup interval of processor CPU1) of the real-time clock RTC, the LED intensity which stores the light amount of an infrared light emitting diode, the ring buffer size of the RAM which stores the capacity of the ring buffer RNG1 set in the main memory RAM, and the area of the EEPROM ring buffer size which stores the capacity of the ring buffer RNG2 set in the nonvolatile memory EEPROM. It also includes a transfer voltage preset value which stores a threshold for determining whether or not to transfer data from the main memory RAM to the nonvolatile memory EEPROM, in the nonvolatile memory EEPROM, a transfer data flag which shows whether or not there is any data transferred from the main memory RAM to the ring buffer RNG2 of the nonvolatile memory EEPROM, an untransmitted data number which shows the number of untransmitted sensing data stored in the ring buffer RNG2, a write address which shows the position at which to write the latest sensing data in the ring buffer RNG2, and a read address which shows the position at which to read untransmitted sensing data from the ring buffer RNG2.

As described later, if the voltage of the battery BAT is less than a threshold stored in the transfer voltage preset value, the processor CPU1 will transmit the untransmitted sensing data in the ring buffer RNG1 of the main memory RAM to the ring buffer RNG2 of the EEPROM. At this time, the processor CPU1 writes sensing data from the address of the nonvolatile memory EEPROM set as the write address, sets the transfer data flag, writes the number of untransmitted sensing data written to the ring buffer RNG2 as the number of untransmitted data, and sets the next address at which writing was completed, as the write address to which write should be performed on the next occasion. The read address is “backtracked” by incrementing the address of the ring buffer RNG2 each time transmission of untransmitted sensing data is completed.

n addresses #1-#n which store untransmitted sensing data are set in the ring buffer RNG2, and the time at which sensing data was acquired, the temperature measured by the temperature sensor, the acceleration measured by the acceleration sensor and the pulse rate measured by the pulse sensor as sensing data, are stored in each of the addresses #1-#n. The ring buffer RNG2 starts writing or reading from address #1, and when it reaches the last address #n, it returns to the following address #1, and the predetermined memory space is recycled. After the addresses have gone through one cycle when sensing data is stored, the next address which stored the oldest sensing data is overwritten, and new sensing data is stored with priority.

### <Main Memory RAM>

Next, the contents of the main memory which stores the latest physiological data and untransmitted physiological data (untransmitted data) will be described referring to FIG. 7.

In the main memory RAM, the parameter area VAL which stores control parameters of the sensor SN1 and the ring buffer RNG1 which stores untransmitted sensing data, are set.

In the parameter area VAL, a delayed transmission data storage location showing the storage location where untransmitted sensing data (delayed transmission data) is stored in either or both of the main memory RAM and the nonvolatile memory EEPROM, is set. In the delayed transmission data storage location, for example, “0” shows a RAM mode wherein untransmitted sensing data is stored only in the ring buffer RNG1 of the main memory RAM, “1” shows an EEPROM mode wherein untransmitted sensing data is stored only in the ring buffer RNG2 of the nonvolatile memory EEPROM, and “2” shows a mixed mode wherein untransmitted sensing data is stored in both memories, i.e., the ring buffer RNG1 and ring buffer RNG2 connected together.

The parameter area VAL contains an EEPROM untransmitted data number showing the number of untransmitted sensing data stored in the ring buffer RNG2 of the nonvolatile memory EEPROM, an EEPROM write address showing the location where new sensing data is stored in the ring buffer RNG2, and EEPROM read address showing the location where untransmitted sensing data is read from the ring buffer RNG2, a RAM untransmitted data number showing the number of untransmitted sensing data stored in the ring buffer RNG1 of the main memory RAM, a RAM write address showing the location where new sensing data is written in the ring buffer RNG1, and a RAM read address showing the location where untransmitted sensing data is read from the ring buffer RNG1.

As described above, if the voltage of the battery BAT exceeds a threshold value stored in a transfer voltage setting value, the processor CPU1 writes untransmitted sensing data to the ring buffer RNG1 of the main memory RAM, and if it is equal to or less than the threshold value, the contents of the ring buffer RNG1 are forwarded to the ring buffer RNG2 of the EEPROM, and subsequent untransmitted sensing data is written to the ring buffer RNG2.

During write to the main memory RAM, the processor CPU1 writes sensing data from an address of the ring buffer RNG1 set in a RAM write address, increments the number of untransmitted RAM data, and sets the next address for which write is completed in a RAM write address as the next write address. The RAM read address is “backtracked” by incrementing the address of the ring buffer RNG1 each time transmission of untransmitted sensing data is completed. Write to the ring buffer RNG2 is identical to that of the aforesaid FIG. 6.

In the ring buffer RNG1, n addresses #A1-#An which store the untransmitted sensing data of FIG. 6 are set, and each address #A1-#An stores the time at which physiological data was acquired, and the temperature measured by the temperature sensor, the acceleration measured by the acceleration sensor and the pulse rate measured by the pulse sensor as physiological data.

If the delayed transmission data storage location is “0”, the ring buffer RNG1 starts write or read from the address #A1, and when the final address #An is reached, the next address returns to #A1, and a predetermined memory is recycled. If the addresses have completed one cycle when sensing data is stored, the next address which stored the oldest sensing data is overwritten, and new sensing data is stored with priority.

If the delayed transmission data storage location is “2”, the ring buffer RNG1 starts write or read from the address #A1, and when the final address #An is reached, the next address is set as #1 of the ring buffer RNG2, and the two memory spaces are recycled. If the address has completed one cycle when the sensing data is stored, the next address which stored the oldest sensing data is overwritten, and new sensing data is stored with priority.

The flash memory FROM simply stores the control program P100 of the sensor node SN1, and will not be described in detail.

### <Untransmitted Data Storage Processing>

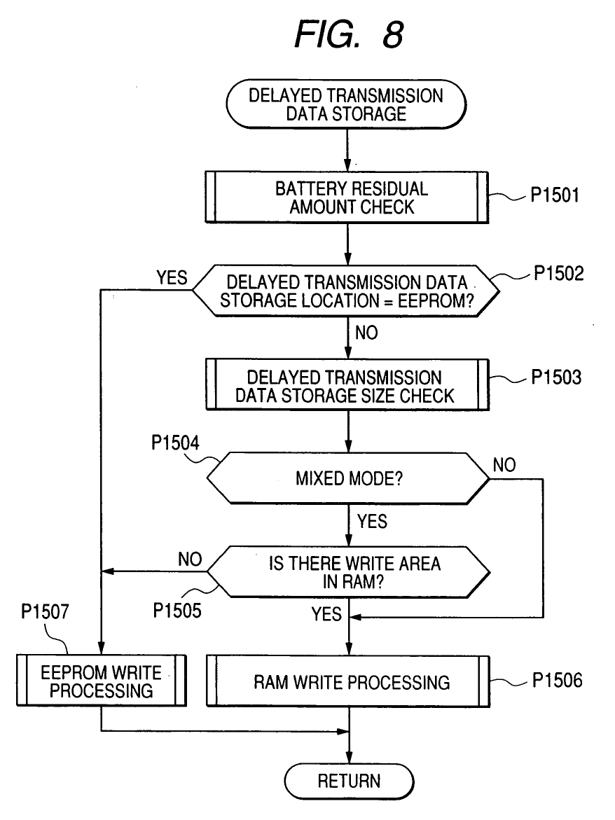

Next, an example of the write processing for untransmitted sensing data (delayed transmission data) performed by P147 of FIG. 5 will be described based on the flow chart of FIG. 8.

When untransmitted sensing data is stored, first, it is determined whether or not the remaining amount (capacity) of the battery BAT is sufficient and if the remaining amount (voltage) of the battery BAT is equal to or less than a preset EEPROM transfer voltage setting value, the sensing data stored in the ring buffer RNG1 of the main memory RAM is forwarded to the nonvolatile memory EEPROM, and previously transmitted sensing data is protected in the nonvolatile memory EEPROM (P1501).

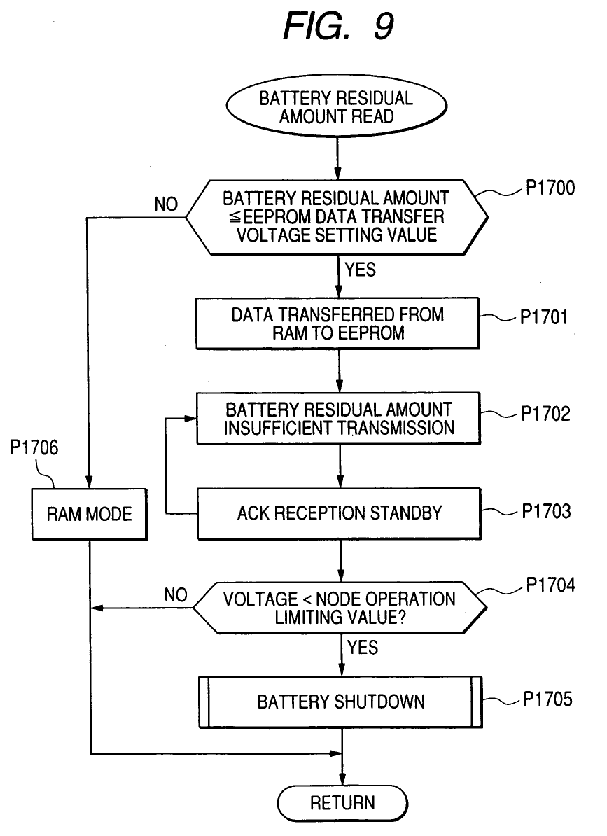

A specific example of the processing of P1501 is shown in FIG. 9.

In FIG. 9, the battery remaining amount (voltage) and the EEPROM data transfer voltage setting value stored in the nonvolatile memory EEPROM are compared (P1700), and if the measured voltage of the battery BAT is equal to or less than the EEPROM data transfer voltage setting value, the routine proceeds to P1701, and the data in the main memory RAM (parameter area VAL and ring buffer RNG1) is forwarded to the nonvolatile memory EEPROM. At this time, an EEPROM data transfer flag of the nonvolatile memory EEPROM is set to ON, and subsequently operation is performed in the EEPROM mode.

On the other hand, if the measured voltage of the battery BAT exceeds the EEPROM data transfer voltage setting value, the routine proceeds to P1706, sets the RAM mode which writes untransmitted sensing data to the ring buffer RNG1, and processing is terminated.

After the main memory RAM has been transferred to the nonvolatile memory EEPROM, a notification is given to the base station BS10 that the remaining amount of the battery BAT is insufficient (P1702). When the reply signal ACK is received from the base station BS10 (P1703), in P1704, it is determined whether or not the voltage of the battery BAT is less than a preset node operation limiting value. If the voltage of the battery BAT is less than the node operation limiting value, the routine proceeds to P1705, the power supply is shut off, and the sensor node SN1 is stopped. On the other hand, if the voltage of the battery BAT is equal to or greater than the node operation limiting value, processing is terminated as it is.

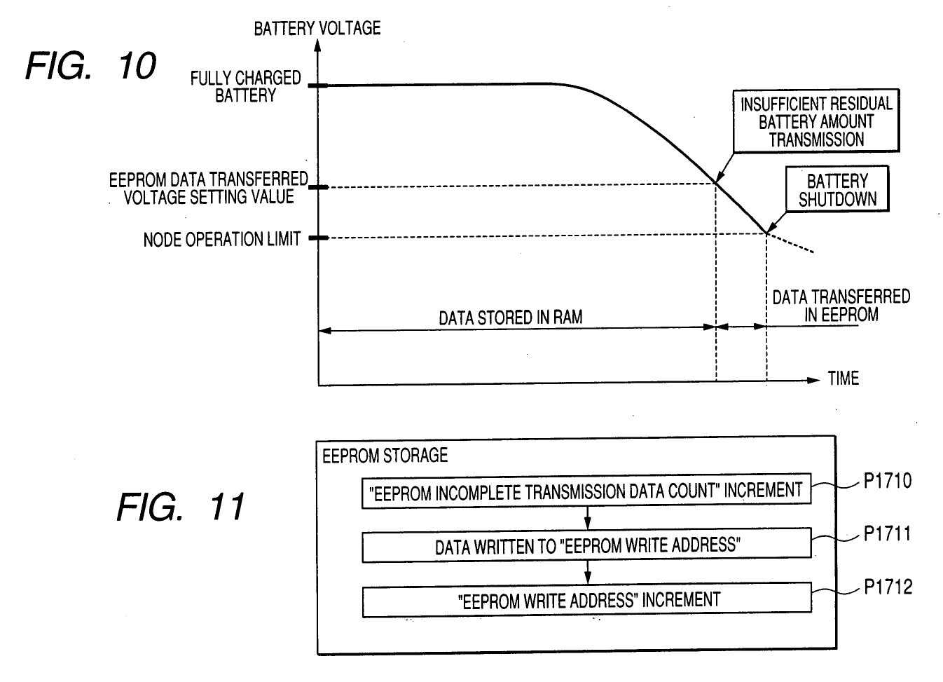

Due to the above processing, as shown in FIG. 10, the voltage of the battery BAT decreases together with elapsed time, and if it falls below the EEPROM data transfer voltage setting value, the data in the main memory RAM is transferred to the nonvolatile memory EEPROM, and a notification is given to the base station BS10 that the remaining amount of the battery BAT is insufficient. Further, if the voltage of the battery BAT decreases so that it falls below the predetermined node operation limiting value, the power supply is shut off and the sensor node SN1 is stopped. Therefore, during the interval when the remaining amount of the battery BAT exceeds the EEPROM data transfer voltage setting value, the system basically operates in the RAM mode and untransmitted sensing data is written to the ring buffer RNG1, and when the remaining amount of the battery BAT falls, the system operates in the EEPROM mode and untransmitted sensing data is stored in the ring buffer RNG2. Hence, when the remaining amount of the battery BAT falls lower than the node operation limiting value, sensing data is transferred to the nonvolatile memory EEPROM even if the contents of the volatile memory are erased, so previous data can be read even if the battery BAT is replaced or recharged.

When the battery remaining amount check process is complete, the routine proceeds to P1502 of FIG. 8, and it is determined whether the untransmitted sensing data write operation is the EEPROM mode. If it is the EEPROM mode, in P1507, untransmitted sensing data is written to the nonvolatile memory EEPROM. If it is the RAM mode, in order to determine whether or not to shift to the mixed mode, the routine proceeds to a delayed transmission data storage size check processing of P1503.

Here, the EEPROM write processing performed by the aforesaid P1507 is the flow chart shown in FIG. 11.

First, 1 is added to increment the number of untransmitted EEPROM data of the parameter storage part PRM of the nonvolatile memory EEPROM (P1710). Next, the EEPROM write address (pointer) is read from the parameter storage part PRM, and the latest sensing data is written to the corresponding address of the ring buffer RNG2 (P1711). When write is complete, a predetermined value is added to increment the EEPROM write address, and update it to the next write position (P1712). However, if the result of adding the predetermined value to the present EEPROM write address exceeds the final address #n shown in FIG. 6, the first address #n of the ring buffer RNG2 is set.

Next, in the delayed transmission data storage size check process performed in P1503, as shown in FIG. 12, when the ring buffer RNG1 of the main memory RAM is full, the routine shifts to the mixed mode wherein the ring buffer RNG2 of the nonvolatile memory EEPROM is connected so that the two ring buffers are used as one ring buffer. When the RAM write address of the ring buffer RNG1 of the main memory RAM reaches its maximum capacity (#An in FIG. 7), “2” is set to the delayed transmission data storage location of the parameter area VAL of the main memory RAM, and the mixed mode is set. In the mixed mode, to identify whether to write to the ring buffer RNG1 of the memory RAM or the ring buffer RNG2 of the nonvolatile memory EEPROM, in addition to the identifier showing the mode, an identifier showing the write location is added to the delayed transmission data storage location of the parameter area VAL. For example, when data is written to the ring buffer RNG1 of the main memory RAM in the mixed mode, “30” is set, and when data is written to the ring buffer RNG2 of the nonvolatile memory EEPROM in the mixed mode, “31” is set.

Next, in P1504 of FIG. 8, it is determined whether or not the mode is the mixed mode from the value of the delayed transmission data storage location of the parameter area VAL. If it is the mixed mode, the routine proceeds to P1505, and if it is not the mixed mode, the routine proceeds to P1506 and the latest sensing data is written to the main memory RAM.

In P1505, the location where data is to be written is determined from the identifier of the delayed transmission data storage location. If data is to be written to the ring buffer RNG1 of the main memory RAM, the routine proceeds to P1506, and if data is to be written to the ring buffer RNG2 of the nonvolatile memory EEPROM, the routine proceeds to P1507.

The RAM write processing of P1506 is performed in an identical way to the EEPROM write processing of FIG. 11. Specifically, 1 is added to increment the number of untransmitted RAM data in the parameter area VAL of the main memory RAM. Next, the RAM write address (pointer) is read from the parameter area VAL, and the latest sensing data is written to the corresponding address of the ring buffer RNG1. When write is complete, a predetermined value is added to increment the RAM write address, and update it to the next write position. However, if the result of adding the predetermined value to the present RAM write address exceeds the final address #An shown in FIG. 7, the first address #A1 of the ring buffer RNG1 is set.

Due to the above processing, if the reply signal ACK in response to the transmitted sensing data was not received due to a unstable wireless communication state or a fault in the base station BS10, the latest sensing data is stored in one of the ring buffers RNG1, 2 of the main memory RAM or nonvolatile memory EEPROM according to the remaining amount of the battery BAT, and is held until the next transmission success.

### <Untransmitted Data Transmission Processing>

As described above, when the processor CPU1 is started on the next occasion, after determining the presence or absence of untransmitted sensing data in P146 of FIG. 5, untransmitted sensing data stored in the ring buffers RNG 1, 2 is read in P148 and transmitted to the base station BS10 in P144.

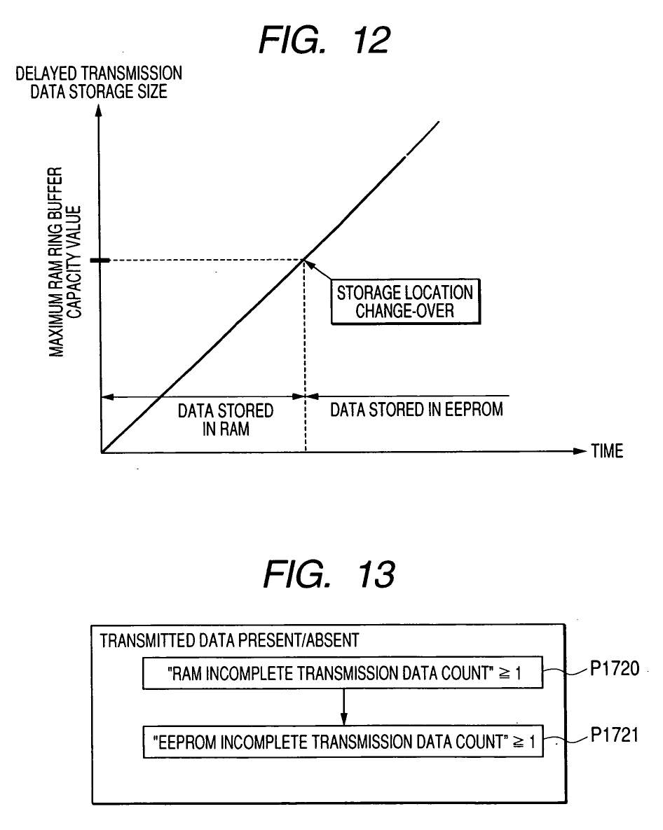

First, in the processing of P146, as shown in FIG. 13, the number of untransmitted RAM data is read from the parameter area VAL of the main memory RAM, and it is determined whether this value is equal to or greater than 1 (P1720), alternatively, the number of untransmitted EEPROM data in the nonvolatile memory EEPROM is read, and it is determined whether this value is equal to or greater than 1 (P1721). If either of these conditions is satisfied, the routine proceeds to the untransmitted data read process P148.

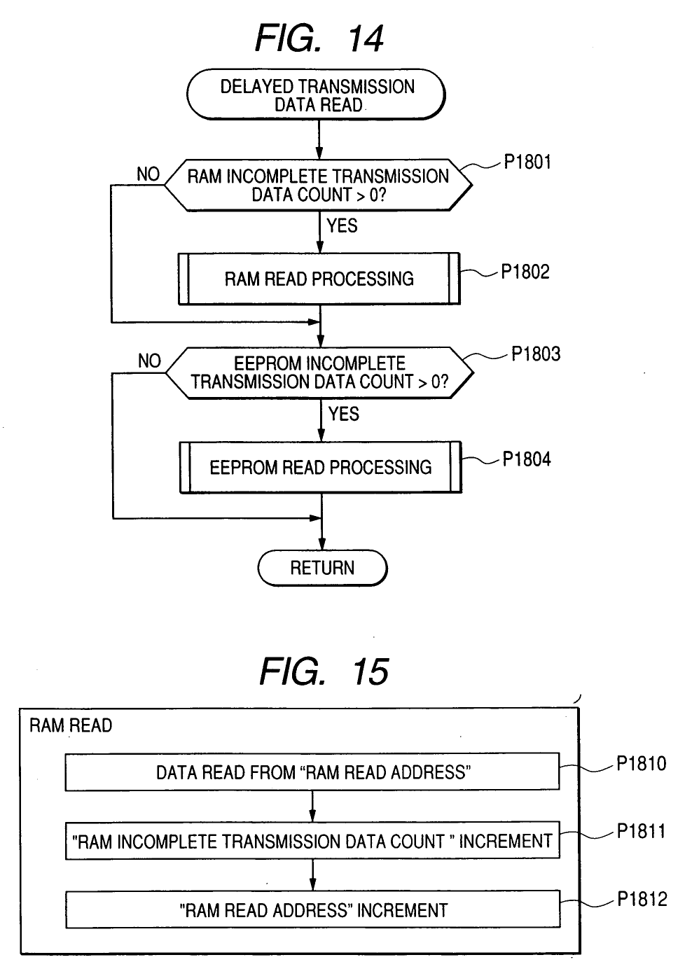

The untransmitted data read processing of P148 is shown in the flow chart of FIG. 14. In FIG. 14, in P1801, the number of untransmitted RAM data in the main memory RAM is read. If the number of untransmitted RAM data exceeds 0, the routine proceeds to P1802, and data is read from the ring buffer RNG1 of the main memory RAM. If the number of untransmitted RAM data is 0, the routine proceeds to P1803.

In P1803, the number of untransmitted EEPROM data in the main memory RAM is read. If the number of untransmitted EEPROM data exceeds 0, the routine proceeds to P1804, and data is read from the ring buffer RNG2 of the nonvolatile memory EEPROM. If the number of untransmitted EEPROM data is 0, the routine is terminated.

Here, the RAM read processing of P1802 is shown in the flow chart of FIG. 15. In FIG. 15, the RAM read address is looked up from the parameter area VAL of the main memory RAM, and data is read from the ring buffer RNG1 which shows the corresponding address (P1810).

Next, 1 is subtracted to decrement the number of untransmitted RAM data in the parameter area VAL (P1811). Next, the RAM read address (pointer) from the parameter area VAL is updated to the next read position (P1812). However, if the result of adding a predetermined value to the present RAM read address exceeds the final address #An shown in FIG. 7, the first address #A1 of the ring buffer RNG1 is set to the next read position. Although not shown in the figure, the EEPROM read processing of P1805 is performed in an identical way to that of the ring buffer RNG1 of the main memory RAM.

As described above, in delayed transmission data read processing, untransmitted data is read sequentially from the ring buffers RNG1, 2 according to the storage mode set according to the remaining amount of the battery BAT or the volume of untransmitted data in P147 of FIG. 5, and is transmitted to the base station BS10 sequentially after the latest sensing data.

### <Base Station Processing>

Next, an example of the operation of the control program of the base station BS10 shown by P200 of FIG. 5 will be described.

When the power of the base station BS10 in FIG. 5 is switched ON (P201), initialization of the resources of the base station BS10 is performed (P210). In this initialization, a wireless channel setting is performed to perform wireless communication with the sensor nodes SN1-SN3 (P211).

When initialization is complete, standby processing for receiving signals from the sensor nodes SN1-SN3 (hereafter, referred to simply as sensor nodes) is performed (P220). In this reception standby processing, in P221, a signal from the sensor nodes is awaited, and when there is a signal from the sensor nodes, in P222, the reply signal ACK is transmitted to the sensor node which sent the signal.

Next, the base station BS10, in P230, analyzes the data type PDT of the received packet, and determines whether it is an association request (subscription request) or sensing data. If it is an association request, in P240, the routine proceeds to association processing and if it is sensing data, the routine proceeds to the sensing data reception processing of P260.

In association processing, a unique node ID under the base station BS10 is determined for the sensor node which made the request, and as the association result, the node ID is notified to the sensor node (P241). The reply signal ACK from the corresponding sensor node is awaited in P242, and when the reply signal ACK is received, the routine proceeds to the time synchronization processing of P250. On the other hand, if the reply signal ACK is not received within a predetermined time, the routine returns to P241, and waits for the reply signal ACK after transmitting the association result. If the reply signal ACK is not received even if this processing is repeated a predetermined number of times (e.g., 3), the routine returns to the reception standby processing of P220 after erasing the determined node ID.

In time synchronization processing, first, the system waits for reception of a time setting command from the sensor node (P251). If there is no request from the corresponding sensor node even after waiting a predetermined time (several hundred msec), this reception waiting returns to the reception waiting processing of P220. On the other hand, if a time setting command is received within the predetermined time, the reply signal ACK is returned to the sensor node (P252), and time information is transmitted in the format shown in FIG. 17 (P253). At this time, a conversion to the format shown in FIG. 17 from the time format of the operating OS is performed in the base station BS10. Although not shown, the base station BS10 synchronizes its time with the time server TSV10 at a predetermined interval. Next, in P254, the system waits for the reply signal ACK from the sensor node which transmitted the time data, and if the reply signal ACK is not received even after waiting the predetermined time, the routine again returns to P253 and transmits the present time. If, in P254, the reply signal ACK from the sensor node is still not received, the processing of the aforesaid P253, P254 is repeated a predetermined number of times, and the routine then returns to the reception standby processing of P220. If the reply signal ACK is received from the sensor node in P254, in P255, the system waits for a time setting complete notification from the sensor node. If this time setting complete notification is not received within a predetermined time in the same way as described above, processing is terminated and the routine returns to the reception standby processing of P220. If the time setting complete notification is received, in P256, the reply signal ACK is transmitted to the corresponding sensor node, processing is terminated and the routine returns to P220.

Next, if sensing data was determined in P230, the routine proceeds to sensing data reception processing (P260). In P261, the received sensing data is sorted in acquisition time order and stored in the database SDB1 (P262). When storage in the database SDB1 is complete, the routine again returns to the reception standby processing of P220. The sorting may also be performed after storage in the database SDB1.

In the sensor node of the invention, if transmission of sensing data on the immediately preceding occasion fails, the sensing data is stored in the predetermined ring buffers RNG1, 2, and when transmission of the latest sensing data is successful, the sensing data which was stored in the ring buffer is RNG1, 2 is collectively transmitted continuously to the base station BS10. At this time, the sensing data stored in the ring buffer RNG1 is repeatedly transmitted. For example, as shown in FIG. 7, transmission is performed sequentially from the first address #A1 to the last address #An of the ring buffer RNG1. For this purpose, in the base station BS10, after the latest sensing data has been received, the oldest sensing data is transmitted in a time series.

If data transmission fails when the data stored in the ring buffers RNG1, 2 is transmitted, the sensor node “backtracks” one pointer (read address) of the ring buffer which is presently being read, and enters the standby state. Also, when the data stored in the ring buffers RNG1, 2 is transmitted, transmission of data in the ring buffer which is presently being read continues without receiving an interrupt from the real-time clock RTC. Due to this, smooth and stable processing can be performed. Alternatively, when data stored in the ring buffers RNG1, 2 is transmitted, if an interrupt is received from the real-time clock RTC, the routine may “backtrack” one pointer (read address) of the ring buffer which is presently being read, and after sensing is performed, the data in the ring buffer may be retransmitted after this latest data. Due to this, the latest sensing data is given more importance and transmitted with high priority, and data loss can also be prevented. Also, the latest sensing data can be stored in the ring buffer without transmission, and the latest sensing data transmitted after data already stored in the ring buffer, which was in the processing of being read, is transmitted.

Hence, in the base station BS10, by sorting received sensing data for each sensor node in the acquisition order contained in the sensing data, the sensing data of each sensor node can be managed in a time series in the database SDB1.

### <Power Consumption of Sensor Node>

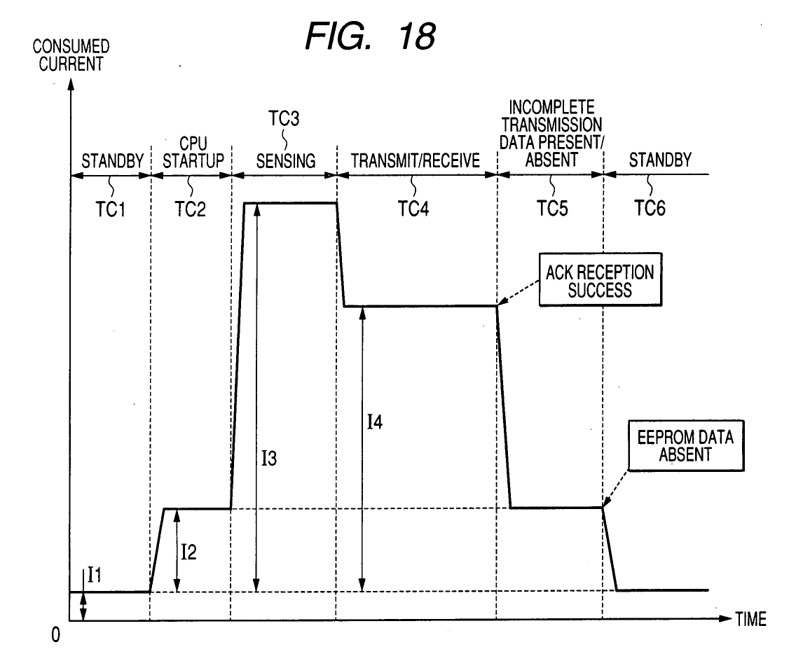

Next, the power consumption of the sensor node will be described. First, FIG. 18 shows the case where the sensor node is started from the standby state by a timer interrupt from the real-time clock RTC, and transmission of sensing data is performed normally.

At a time TC1, the processor CPU1 is in a software standby mode, and the power consumption is suppressed to a minimum I1 (e.g., 1 μA or less). When a predetermined time has elapsed on the real-time clock RTC, at a time TC2, a real-time clock RTC interrupt is generated, the processor CPU1 is started, and P100 of FIG. 5 is started from the standby state. Due to startup of the processor CPU1, at the time TC2, the current increases to a maximum I2 (=5 mA).

The measurement of physiological data is performed at a time TC3. The temperature sensor, acceleration sensor and pulse sensor are activated sequentially so as to measure the temperature, acceleration and pulse. During the interval of this time TC3, the power consumption is a maximum, and a power of I1+I3 (10-50 mA) is consumed.

When sensing of physiological data is complete, the sensors are switched OFF, and driving of a radio-frequency part RF starts at a time TC4. During the interval of the time TC4, communication with the base station BS10 is performed, data is sent and commands are received as described above. The power consumption during the interval of this time TC4 is I1+I4 (=20 mA), which is the second-largest power consumption.

When transmission of sensing data at the time TC4 and reception of the reply signal ACK are complete, a radio-frequency part RF is switched OFF, and at a time TC5, it is determined whether or not there is any untransmitted data in the main memory RAM or EEPROM. The power consumption during this interval is I1+I2 which is the same as during the interval TC2. If there is no untransmitted data, at a time TC6, the processor CPU1 shifts to the standby state. The CPU1 shifts to the standby state at the time TC6 after setting the real-time clock RTC and other devices, and the aforesaid cycle TC1-TC5 is repeated.

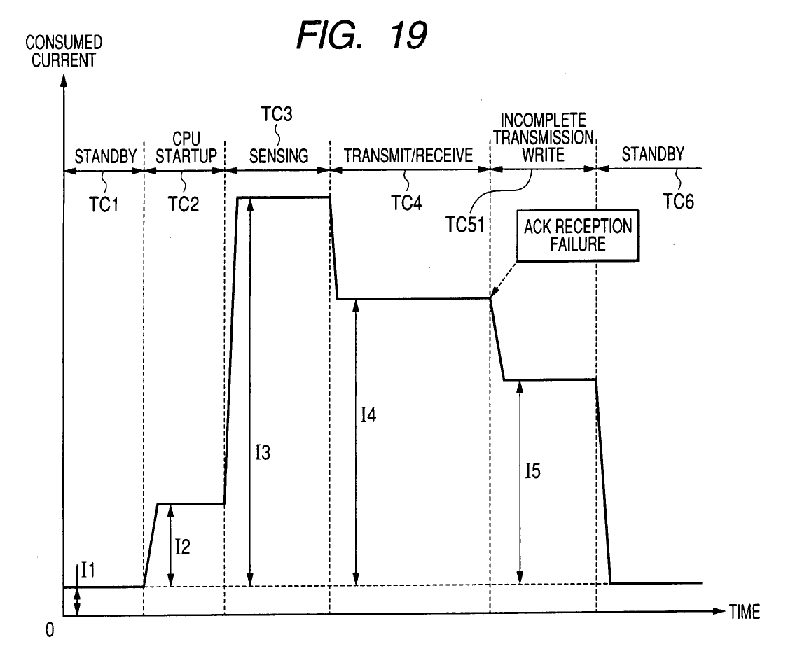

FIG. 19 shows the case where the sensing node transmits sensing data, and writes it to the ring buffer RNG2 without receiving the reply signal ACK from the base station BS10 in the normal way. The intervals TC1-TC4 and TC6 are identical to the normal example of FIG. 18. During an interval TC51, since the reply signal ACK was not received from the base station BS10, the measured sensing data is written to the nonvolatile memory EEPROM. During this interval TC51, the current written to the nonvolatile memory EEPROM is a current I5 added to the aforesaid current I2, which is the third-largest power consumption. After write is complete, the system again enters the standby state as in the aforesaid FIG. 18, and the current is suppressed to I1.

However, in the invention, since reception waiting for the reply signal ACK from the base station BS10 and retransmission of sensing data is limited to a predetermined number of times (e.g., 3), by shortening the transmit/receive interval TC4 which has the second-largest power consumption, the wear of the battery BAT can be suppressed. Further, in the aforesaid RAM mode, the current required for write can be further reduced, so the wear of the battery BAT can be further suppressed, and the maintenance interval of the battery BAT can be increased.

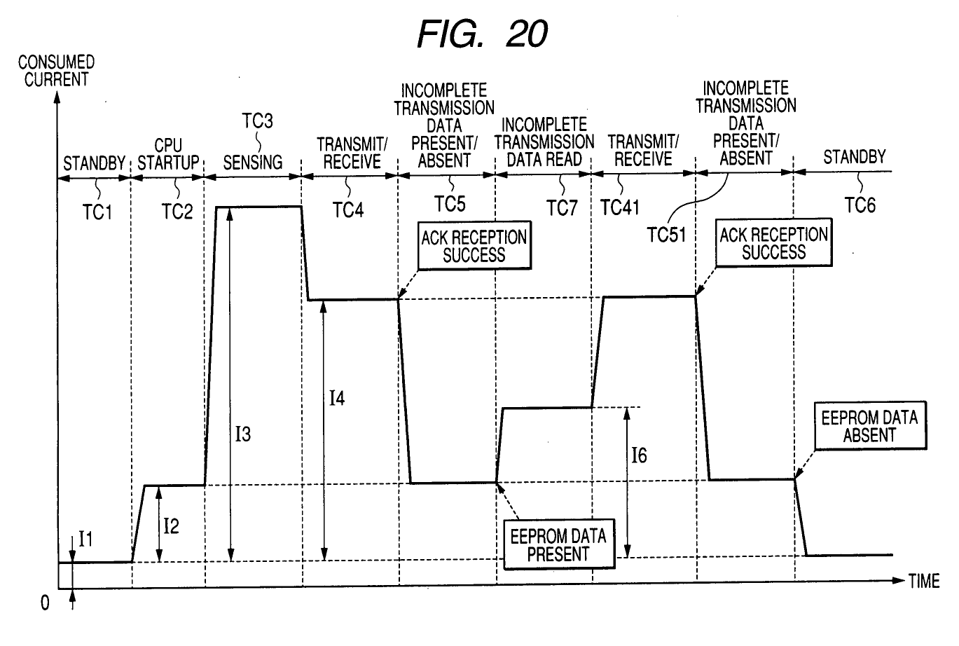

FIG. 20 shows the case where, in FIG. 19, untransmitted data written to the ring buffer RNG1 or 2 is transmitted to the base station BS10. Up to the intervals TC1-TC5, physiological data is measured in the same way as for FIG. 18, sensing data is transmitted to the base station BS10, and the reply signal ACK is received. In the present case, untransmitted data is written to the ring buffers without receiving the reply signal ACK from the base station BS10 on the immediately preceding startup (FIG. 19), and this untransmitted data is transmitted to the base station BS10.

In the interval TC5, after the reply signal ACK was successfully received from the base station BS10, it is determined whether or not there is untransmitted data in the ring buffers RNG1 or 2. The immediately preceding sensing data is stored in the ring buffers RNG1 or 2, so during an interval TC7, untransmitted data is read from the main memory RAM or nonvolatile memory EEPROM. Consequently, during the interval TC7, power consumption again increases and becomes the fourth largest, I6.

After read is complete, during an interval TC41 for retransmitting data to the base station BS10, the power consumption increases to I4 since a radio-frequency part RF is activated. After receiving the reply signal ACK from the base station 10, during the interval TC51, it is determined whether or not there is any remaining untransmitted data. In this example, all the untransmitted data in the ring buffers RNG1 or 2 was transmitted, so the routine shifts to the interval TC6 and again returns to the standby state.

Hence, in the invention, power consumption is suppressed by acquiring data at a predetermined interval. In other words, apart from sensing data acquisition, write and read of untransmitted data, and transmission/reception of sensing data, the system is in the standby state, and during the standby state power consumption can be largely suppressed (e.g., 1 μA or less). Also, the latest sensing data is transmitted, and the wireless communication state is verified. In other words, since the sensor node transmits the latest sensing data which is the normal operation at a predetermined interval, the quality of the communication state can be determined, processing which exclusively verifies the communication state is not required, and wear of the battery BAT can be suppressed. Further, when the latest sensing data is successfully transmitted, the sensing data stored in the ring buffers RNG1 or 2 is transmitted together. Due to this, the power used for data transmission/reception and memory access is suppressed to the minimum, and the durability of the sensor node which must operate for a long period with the battery BAT, can be increased.

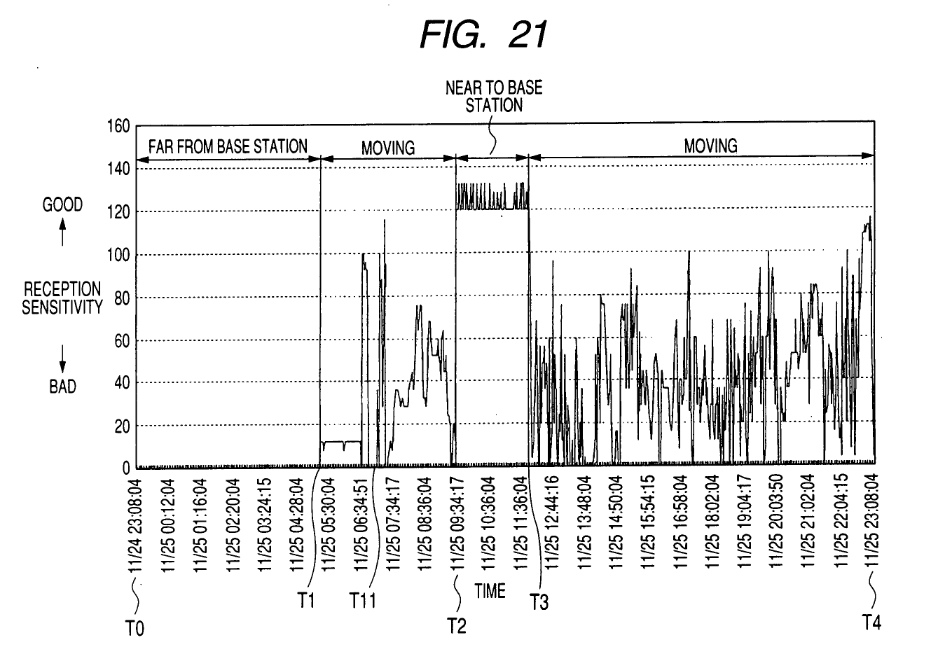

FIG. 21 shows the relation between the movement (position) of a person fitted with the sensor node SN1, and the reception sensitivity of the sensor node SN1 at the base station BS10. If the reception sensitivity in the diagram is 1 or more, the base station BS10 and sensor node SN1 can communicate.

During the time T0-T1, the sensor node SN1 is far away from the base station BS10, and transmission/reception cannot be performed. During this interval, if the processor CPU1 is started, since the sensor node SN1 cannot receive the reply signal ACK from the base station BS10, sensing data is accumulated in the ring buffers RNG1 or 2. When the wearer of the sensor node SN1 moves towards the base station BS10, from the time T1, the sensor node can communicate with the base station BS10.

If the processor CPU1 of the sensor node SN1 is started immediately after this time T1, first, the sensor node SN1 transmits the latest sensing data to the base station BS10, and previous sensing data stored in the ring buffers RNG1 or 2 is transmitted to the base station BS10 in the oldest order. However, during the time interval T1-T2, since the wearer of the sensor node SN1 is approaching the base station BS10, the reception sensitivity of the base station BS10 changes. For example, at a time T11, the reception sensitivity is temporarily 0, and the sensor node SN1 cannot communicate with the base station BS10. At this time T11, if the sensor node SN1 is communicating with the base station BS10, the reply signal ACK from the base station BS10 can no longer be received, so transmission of the accumulated sensing data is interrupted midway. At this time, the address of the ring buffer RNG1 or 2 for which read was interrupted is set to the read address of the EEPROM of the main memory RAM or RAM read address as the read start position on the next occasion.

During the time interval T2-T3 when the wearer of the sensor node SN1 is approaching the base station BS10, reception sensitivity is stable at a high level, so the sensing data which was interrupted at the aforesaid time T11 can be transmitted stably. At the time T3-T4, the wearer of the sensor node SN1 moves to a position far from the base station BS10, and the reception sensitivity falls as shown in the diagram. Since the reception sensitivity changes even within the communication range of the base station BS10, the reception sensitivity may instantaneously even fall to 0. Hence, communication between the sensor node SN1 and base station BS10 may be interrupted even within the communication range. In the invention, when the wireless communication state become unstable, the measured sensing data is stored in a storage device such as the main memory RAM or nonvolatile memory EEPROM, so by transmitting the accumulated sensing data together when the wireless communication state has recovered, data loss in the database SDB1 of the base station BS10 can be suppressed and sensing data accumulated in a time series while preventing unnecessary wear of the battery BAT of the sensor node SN1.

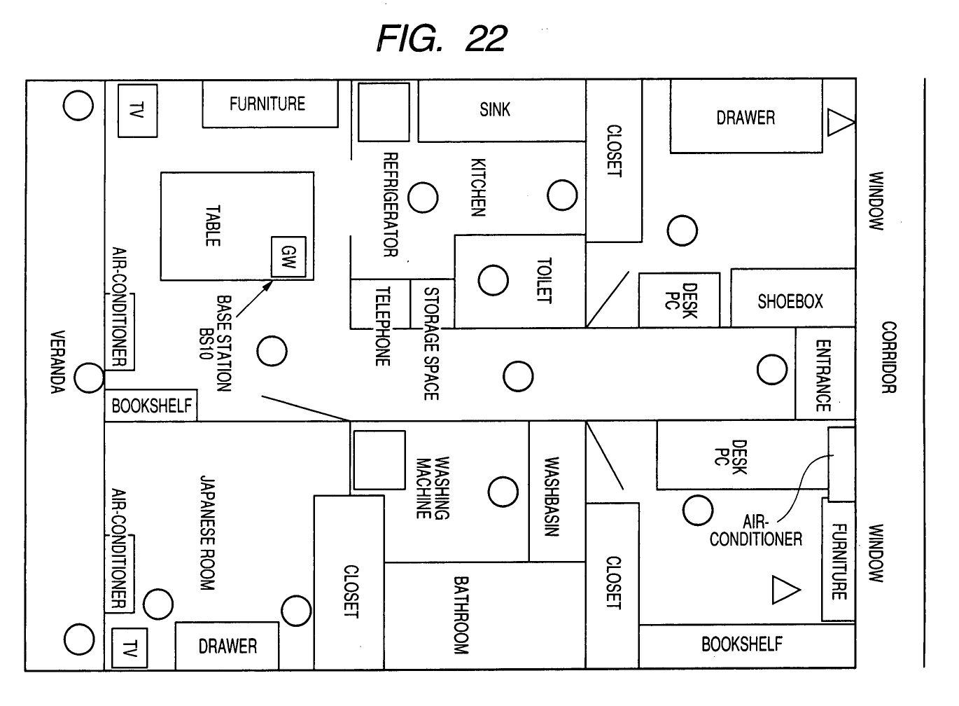

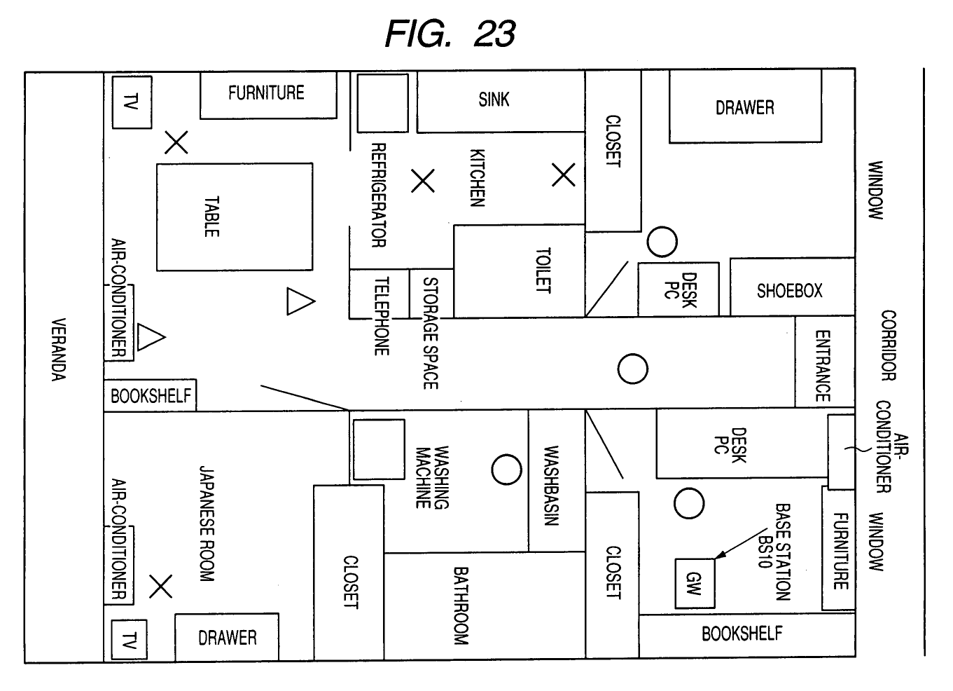

The aforesaid change of reception sensitivity depends on the position in a residence shown in FIG. 22, FIG. 23, and the transmission intensity of the sensor node SN1 shown in FIG. 25.

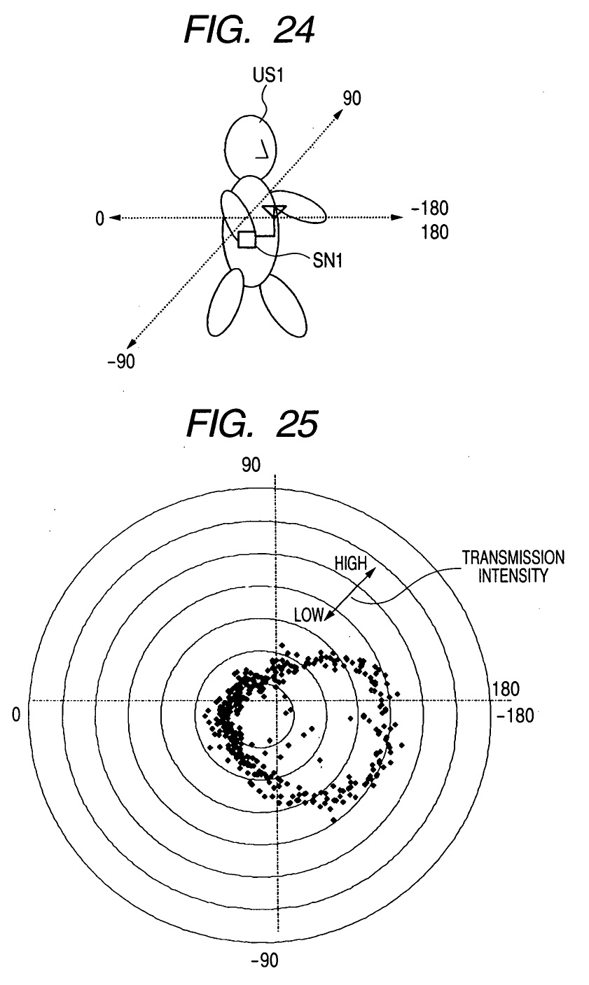

In FIG. 22, when the base station BS10 is installed on a table near the kitchen, “O” in the figure shows a position where the wireless communication state is stable, and “Δ” shows a position where the wireless communication state is rather unstable. On the other hand, the transmission intensity when the wrist-band type of the sensor node SN1 is fitted to a person, is shown in FIG. 24, FIG. 25.

In FIG. 24, the wrist-band type sensor node SN1 is fitted to the right hand, and FIG. 25 shows the transmission intensity in the plane of the sensor node SN1 when the front of the wearer is 180° (−180°), the right-hand side is −90°, the left-hand side is 90° and immediately behind the wearer is 0°. If the frequency band for performing wireless communication is the 2.4 GHz band, the human body absorbs these radio waves, so as shown in FIG. 25, the transmission intensity is high on the right-hand side of the wearer, and the transmission intensity becomes weaker from the left-hand side to the rear of the wearer.

Hence, even if the wireless communication state in the entrance hall away from the base station BS10 in the residence of FIG. 22 is good, the wireless communication state may become unstable when the wearer turns his back towards the base station BS10. In the vicinity of the wardrobe in the corridor where reception sensitivity is rather unstable, when the wearer has his back turned towards the base station BS10, the wireless communication state become unstable, and the sensing data of the sensor node SN1 can no longer be transmitted to the base station BS10. As shown in FIG. 22, even in a residence where the wireless communication state is stable overall, the wireless communication state varies according to the relation between the wearer's orientation and the position of the base station BS10. Further, as shown in FIG. 23, in a residence where the wireless communication state is basically unstable, the wireless communication state becomes more unstable.

In FIG. 23, “O” in the figure shows a position where the wireless communication state is stable, “Δ” shows a position where the wireless communication state is rather unstable, and “X” shows a position where the wireless communication state is unstable. In the example of this residence, the room arrangement is identical to that of FIG. 22, but since the base station BS10 is installed in a room near the corridor which is far from the table near the veranda, the wireless communication state become unstable overall due to the effect of the walls between the living rooms, etc. In the case of the residence of FIG. 23, the positions where the sensor node SN1 can transmit sensing data to the base station BS10 are the room where the base station BS10 is installed where the wireless communication state is stable, the entrance, the washbasin and the rooms with wardrobes, and although it is rather unstable, transmission may still be possible in the vicinity of the table.

Considering the transmission intensity characteristics of the sensor node SN1 shown in FIG. 25, when the wearer is near the table, kitchen or Japanese room which are far from the base station BS10, sensing data cannot be transmitted, and even in the vicinity of the table where the wireless communication state is rather unstable, if the wearer has his back turned towards the base station BS10, communication may also not be possible.

However, in the sensor node SN1 of the invention, if the reply signal ACK cannot be received from the base station BS10, transmission of sensing data is no longer performed after a predetermined number of times, and by accumulating the data in a storage device such as the main memory RAM or nonvolatile memory EEPROM, unnecessary wear of the battery BAT is prevented. When communication with the base station BS10 is successful on the next occasion that sensing data is transmitted, the previous sensing data which was accumulated in the storage device is transmitted. Consequently, even in a residence where the wireless communication state is unstable overall as shown in FIG. 23, if the CPU1 starts up when the wearer is in the vicinity of the base station BS10 or in a position where the communication state is stable, the sensing data can be transmitted to the base station BS10. Due to this, the base station BS10 can suppress loss of sensing data due to changes in the wireless communication state.

### Embodiment 2

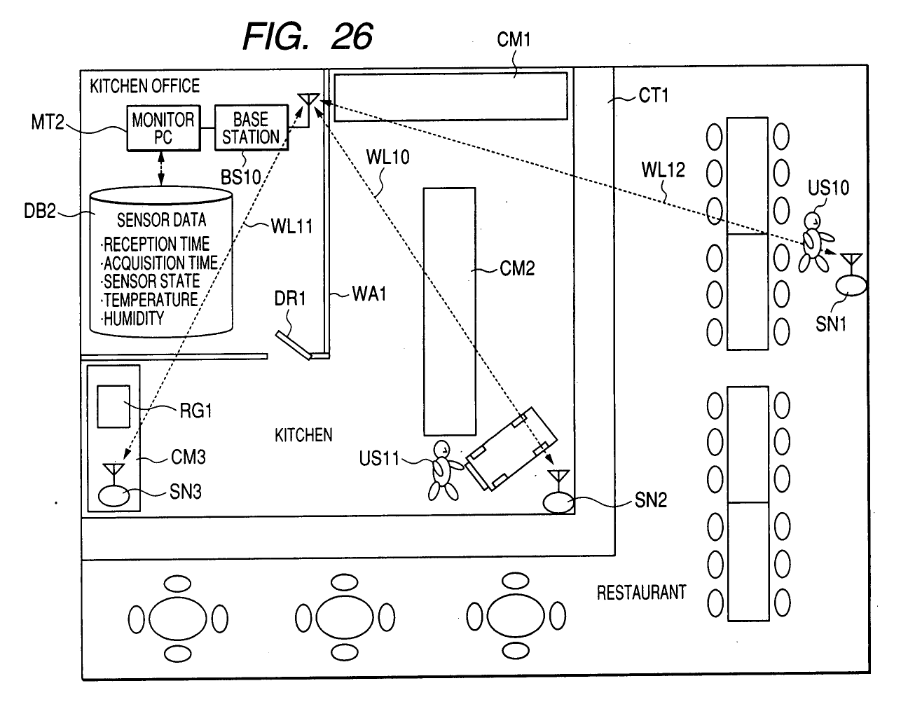

FIG. 26 shows a second embodiment wherein, in a sensor network, the sensor nodes SN1-SN3 of the first embodiment are provided with a humidity sensor instead of the acceleration sensor and pulse sensor, and the temperature/humidity of the kitchen and dining room from the temperature sensor and humidity sensor are collected and managed by the base station BS10 via radio WL10-WL12. The base station BS10 is connected to a monitor PC (MT2) which displays the collected temperature and humidity, and to a database DB2 which stores the collected temperature and humidity.

In this second embodiment, the point that the sensor nodes SN1-SN3 are fixed at predetermined positions in the kitchen and dining room is different from the first embodiment. Also, devices (microwave range, etc.) which use the same wavelength as the wireless communication frequency of the sensor nodes SN1-SN3 and the base station BS10 are installed in the kitchen, and the wireless communication state of the sensor network changes according to the operating state of these devices.

Cooking ranges CM1-CM3 are disposed at predetermined positions in the kitchen, and a kitchen office where the base station BS10 is installed, is set up adjacent to the kitchen. The kitchen office is separated from the kitchen by a wall WA1 and a door DR1. A counter CT1 is set up between the kitchen and dining room.

The sensor node SN1 is fixed at a predetermined position of the dining room, the sensor node SN2 is fixed at predetermined position on the counter CT1, and the sensor node SN3 is fixed on the cooking range CM3. Also, a microwave range RG1 is installed on this cooking range CM3. This microwave range RG1 uses radio waves of the same wavelength as the wireless frequency of the sensor network (e.g., 2.4 GHz band).

The sensor nodes SN1-SN3 start the processor CPU1 at a predetermined interval in the same way as that of the first embodiment, and transmit the latest sensing data to the base station BS10. If the reply signal ACK from the base station BS10 is not received, transmission is retried for a predetermined number of times, and if the reply signal ACK from the base station BS10 is still not received, the sensing data is accumulated in a storage device of the sensor nodes SN1-SN3 (main memory RAM or nonvolatile memory EEPROM). When sensing data is transmitted on the next occasion, the sensor nodes SN1-SN3 transmit the previous sensing data accumulated in the storage device together with it.

When the microwave range RG1 is operating, the wireless communication state of the sensor network become unstable. Further, the wireless communication state become unstable also when the door DR1 of the kitchen office is closed, when persons US10, 11 approach the sensor nodes SN1-SN3, or when a goods cart approaches.

Therefore, the fixed sensor nodes SN1-SN3 are continually in a wireless communication state which is fluctuating, in the same way as when the sensor nodes are mobile as in the first embodiment.

For example, if the processor CPU1 starts when the microwave range RG1 is operating, the sensor node SN3 cannot communicate with the base station BS10, so the latest sensing data is accumulated in the storage device. When the microwave range RG1 is not operating and the processor CPU1 starts, after the latest sensing data is successfully transmitted, the accumulated previous sensing data can be transmitted. The situation is identical for the other sensor nodes SN2, SN3. If the door DR is closed or persons who absorb electromagnetic waves approach during operation of the microwave range RG1, it may not be possible to communicate with the base station BS10, so the sensing data is stored in the wearer's storage device, and when the wireless communication state has improved, the sensing data is transmitted to the base station BS10.

In this way, the invention can be applied not only to the case of mobile sensor nodes, but also to the case where the wireless communication state changes even if the sensor nodes are of the fixed type (stationary type). Hence, as in the first embodiment, unnecessary consumption of the battery BAT of the sensor nodes SN1-SN3 is suppressed, and the maintenance period can be extended. Also, in the base station BS10, the sensing data of the sensor nodes SN1-SN3 can always be received regardless of changes in the wireless communication state, so loss of sensing data can be suppressed.

In the aforesaid embodiment, an example was shown where the main memory RAM which allows read without performing a storage hold operation when there is a power cut, and the nonvolatile memory EEPROM which performs a storage hold operation when there is a power cut, are used together, but only the nonvolatile memory EEPROM may be used. In this case, the main memory RAM can be erased, so the number of components can be reduced. Alternatively, if the main memory RAM is used in conjunction with the flash memory FROM, the ring buffer RNG2 may be set also in the flash memory FROM.

In the aforesaid first embodiment, the case was shown where the base station BS10 and time server TSV10 were independent, but the base station BS10 may have a time server function. Also, in the aforesaid first embodiment, the base station BS10 has the function of the database SDB1 in the secondary storage STR10 with which it is provided, but the base station BS10 and database SDB1 may be independent. Further, in the wide area network WAN10, one each of the base station BS10, monitor terminal MT10 and management server SV10 were shown in the diagrams, but there may be plural thereof.

The processing flow charts in this embodiment are implemented as programs, and may be executed by reading the programs with a computer.

Some examples of the invention have been described, but it will be apparent to those skilled in the art that the invention is not to be construed as being limited in anyway thereby, various modifications and various combinations of the aforesaid embodiments being possible.

As described above, the invention can be applied to sensor nodes and a sensor network which transmit sensing data to a base station by wireless communication. Even if plural sensors are installed, the sensor nodes can be used continuously over a long time period with very low power consumption, so the invention can be applied to sensor nodes and a sensor network where maintenance-free long-term use is required.

What is claimed is:

1. A sensor node, comprising:
a sensor which measures information at a predetermined interval;
a wireless communications part which transmits data measured by said sensor; and
a controller which controls said sensor and said wireless communication part,
wherein said controller includes:
a clock part which starts said sensor at said predetermined interval;
a wireless communication state determining part which, when said sensor measures data, determines a suitable wireless communication state for transmitting a latest of the measurement data;
a storage part which, if the determined wireless communication state is not suitable for transmitting data, stores the latest of the measurement data; and
a data transmission part which, if the determined wireless communication state is suitable, transmits the stored latest of the measurement data.

2. The sensor node according to claim 1, wherein:
said wireless communication state determining part comprises a reply signal receiving part which waits for a response signal corresponding to a capability for receiving said data up to a predetermined time, and a retry part which, if said response signal is not received, repeatedly at predetermined intervals performs transmission of said latest measurement data and reception of said response signal up to a predetermined number of retries; and
if a response signal has not been received by said retry part, said retry part determines that the wireless communication state is not suitable for transmitting data, and, if said response signal has been received, said retry part determines that the wireless communication state is suitable for transmitting data.

3. The sensor node according to claim 1, wherein said controller further comprises a time acquisition part which acquires a time at which said sensor acquired said data, wherein said storage part adds said measurement time to said measurement data and stores it, and said data transmission part adds said measurement time to said measurement data and transmits it.

4. The sensor node according to claim 3, wherein said time acquisition part has a time synchronization part which synchronizes a standard time for said sensor with an actual current time.

5. The sensor node according to claim 1, wherein said data transmission part transmits all of the data stored in said storage part together.

6. The sensor node according to claim 1, wherein said storage part comprises a nonvolatile memory, and said measurement data is stored in said nonvolatile memory.

7. The sensor node according to claim 1, wherein:
said controller further comprises a battery remaining amount detection part which detects a battery remaining amount; and
said storage part comprises a nonvolatile memory and a volatile memory, stores said data in said volatile memory when the detected battery remaining amount exceeds a preset value, and stores said data in said nonvolatile memory when the detected battery remaining amount is equal to or less than a preset value.

8. The sensor node according to claim 7, wherein said storage part stores said data in said volatile memory when said detected battery remaining amount exceeds the preset value, transfers data in said volatile memory to the nonvolatile memory when said detected battery remaining amount is equal to or less than the preset value, and stores said data in said nonvolatile memory once transferred.

9. The sensor node according to claim 8, wherein, when said stored data exceeds the capacity of said volatile memory, said volatile memory and nonvolatile memory are treated as one memory.

10. The sensor node according to claim 7, wherein:
said storage part comprises a first ring buffer set in said volatile memory, and a second ring buffer set in said nonvolatile memory; and
said measurement data is stored in one of said first and said second ring buffer.

11. A base station comprising:
a wireless communication part which measures data at a predetermined interval, and that transmits to and receives from a sensor node data indicating measurements and a measurement time;
a database which stores the data received from said sensor node; and
a controller which controls said wireless communication part and the database,
wherein said controller includes:
a responder which transmits a reply signal to said sensor node when the data is received from said sensor node;
a data extraction part which extracts the measurement data and the time data from said received data;
a sort part which rearranges said measurement data correspondent to said time data; and
a data accumulating part which stores pairs of said rearranged measurement data and said measurement time data in said database.

12. The base station according to claim 11, wherein said data extracting part comprises:
an ID assignment part which extracts a request for subscription to this base station from said received data, and assigns an identifier of said subscription request to said sensor node; and
a time synchronization command part which transmits an actual current time after said sensor node has received said identifier.

13. A sensor network comprising:
a sensor which measures data at a predetermined interval;
a first wireless communication part which transmits the data measured by said sensor to a base station;
a first controller which controls said sensor and said first wireless communication part;
a sensor node comprising said first controller and said first wireless communication part;
a second wireless communication part which transmits and receives data to and from said sensor node;
a database which stores the data received from said sensor node; and
a base station comprising a second controller which controls said second wireless communication part and said database;
wherein the first controller includes:
a clock part which starts said sensor at said predetermined interval;
a wireless communication state determining part which, when said sensor measures the latest data, determines a wireless communication state by transmitting the latest data;
a storage part which, if the determined wireless communication state is a state which is not suitable for transmitting data, stores said latest measurement data; and
a data transmission part which, if the determined wireless communication state is a state which is suitable for transmitting data, transmits said data stored in said storage part; and
wherein the second controller includes:
a responder which transmits a reply signal to the sensor node when the data is received from said sensor node; and
wherein said wireless communication state determining part determines a wireless communication state with the base station based regarding whether said reply signal was received.

14. A method of transmitting sensing data transmitted by a sensor node having a sensor which measures data at a predetermined interval, to a base station, comprising:
starting said sensor at a predetermined interval;
allowing said sensor to transmit a latest of the measurement data to said base station when the sensor measures the latest data;
determining a state of wireless communication with said base station regarding suitability for transmission of said latest data;
storing said measurement data in a storage device of the sensor node if said determined wireless communication state is a state which is not suitable for transmitting data; and
transmitting said data stored in said storage device if said determined wireless communication state is a state which is suitable for transmitting data.

15. The sensing data transmission method according to claim 14, further comprising:
determining whether a reply signal in response to said transmitted data was received from the base station;
performing said transmission and repeating said determination up to a predetermined number of occasions if said determination result is that the reply signal was not received;
determining the state of wireless communication with said base station by determining that said wireless communication state is not suitable for data transmission if said reply signal was not received after said predetermined number of occasions; and
determining that said wireless communication state is suitable for data transmission if said reply signal was received.
